(19) United States
(12) Patent Application Publication
(10) Pub. No.: US 2026/0061782 A1
(43) Pub. Date: Mar. 5, 2026

(54) Tire Inflation Apparatus and CTIS System

(71) Applicants: George Mansour, Diamond Bar, CA (US); Pierre S. Saad, Rancho Cucamonga, CA (US); Ezzat H. Baaklini, La Verne, CA (US)

(72) Inventors: George Mansour, Diamond Bar, CA (US); Pierre S. Saad, Rancho Cucamonga, CA (US); Ezzat H. Baaklini, La Verne, CA (US)

(21) Appl. No.: 19/319,236

(22) Filed: Sep. 4, 2025

Related U.S. Application Data
(60) Provisional application No. 63/690,604, filed on Sep. 4, 2024.

(51) Int. Cl. B60C 23/00

(52) U.S. Cl. CPC B60C 23/00363; B60C 23/00318; B60C 23/00345

(57) ABSTRACT

A tire inflation apparatus is provided herein for inflating and deflating tires through an annular fluid connector which, in part, is connected to and rotates with the wheel of the vehicle. The annular fluid connector includes a sealing body having a hub and an annular channel formed concentrically around the hub with a sealing ring at least partially arranged within the annular channel, with the sealing body and sealing ring permitted to rotated relative to one another. An annular fluid channel is defined between the annular channel and the sealing ring by one or more annular seals, which also form one or more annular oil chambers between the annular seals so that high pressure air within the annular fluid chamber is prevented from seeping past the annular seals.

This application is a 35 U.S.C. § 111 patent application that claims the benefit of priority and is entitled to the filing date pursuant to 35 U.S.C. § 119 (e) of U.S. Provisional Patent Application 63/690,604, filed Sep. 4, 2024, the content of which is hereby incorporated by reference in its entirety.

### BACKGROUND

The subject of this patent application relates generally to tire inflation apparatus and a centralized tire system, and more particularly, to tire inflation apparatus and central tire inflation systems for inflating and/or deflating rotating tires installed on traveling vehicles.

Maintaining proper air pressure in the tires of a vehicle optimizes vehicle safety, reduces operational and maintenance costs, and improves vehicle performance. For example, driving on underinflated or overinflated tires adversely affect the stopping distance of a vehicle, compromise the ride and handling abilities of a vehicle, increase tread wear on the tires, reduce the load bearing capacity of the vehicle, and decrease fuel efficiency of the vehicle.

In addition to the general advantages listed above, improved operational use of a vehicle under certain road conditions or terrain can be achieved by adjusting the air pressure of the tires. For example, on relatively soft ground or rugged terrain, like dirt, sand or gravel, or surface conditions that are clay and muddy, snowy and icy, or rocky, lowering the pressure in a tire creates a larger surface contact between the tire and ground to prevent sinking and slipping and improve traction. This makes driving a vehicle much easier as well as reduces damage to the tread of the tire. On relatively hard ground or terrain, like paved roads, increasing the pressure in a tire at or close to the manufacture's recommended pressure creates a smaller surface contact between the tire and ground that improve traction and mobility as well as increases fuel economy.

Tires lose air pressure through normal driving use, leakage during non-use, and seasonal changes in temperature. For example, a tire can lose one or two psi (pounds per square inch) each month in the winter and even more in the summer. Unfortunately, whether a tire is properly inflated cannot be determined through visual inspection. As such, regularly monitoring of tire pressure using a tire-pressure gauge is required. However, for most operators maintaining proper air pressure in the tires is a task they are negligent to do or find difficult to perform. According to AAA, about 80 percent of vehicles on the road are driving with one or more tires underinflated.

Additionally, in situations where an operator is motivated to monitor and adjust the air pressure of a vehicle's tires, e.g., vehicles used in agricultural fields or recreational off-road sites, these operator's still find the task cumbersome. For example, an operator must stop the vehicle, exit the vehicle, and manually release air or pump air into each tire when conditions change.

What is needed is a tire inflation apparatus and central tire inflation system that permits inflating and/or deflating rotating tires while a vehicle is moving. This central tire inflation system should permit an operator to select a tire inflation pressure for each tire or all tires at a controller, which would then change the tire pressure accordingly while the vehicle continues to travel.

Aspects of the present invention fulfill these needs and provide further related advantages as described in the following summary.

### SUMMARY

Aspects of the present specification disclose a tire inflation system. A tire inflation system disclosed herein is configured to 1) reversibly attach to a hub assembly of a vehicle and 2) receive for reversable attachment a wheel of the vehicle. Additionally, a tire inflation system disclosed herein is configured to integrate into a centralized tire inflation system.

In some aspects of the present specification, a tire inflation system disclosed here can comprise a rotating outer hub comprising a first air channel a stationary inner hub comprising a second air channel, and an annular air channel, the annular air chamber provides gaseous communication between the first air channel and the second air channel. The first air channel provides gaseous communication between a stem valve of a tire and the annular air chamber whereas the second air channel provides gaseous communication between an air source to the annular air chamber. A rotating outer hub of a tire inflation system disclosed herein can further comprise a first annular fluid channel and a second annular fluid channel used to surround the annular air chamber to form a seal to prevent leakage and contamination of the annular air chamber. A rotating outer hub disclosed herein can also comprise an inner air seal, and an outer air seal which form the annular air chamber discloses herein. In yet other aspects, a rotating outer hub discloses herein can comprise a sealing body and an inner sealing ring used to form a first annular fluid channel. A rotating outer hub disclosed herein can also comprise an upper fluid seal used to form a second annular fluid channel. A stationary inner hub of a tire inflation system disclosed herein can further comprise a third annular fluid channel. The third annular fluid channel is in fluid communication with the first annular fluid channel and second annular fluid channel. A stationary inner hub disclosed herein can comprise a lower fluid seal used to form a third annular fluid channel.

In other aspects of the present specification, a tire inflation apparatus comprising a ring housing, a ring housing hose, and a ring assembly hose. A ring housing disclosed herein can comprise a sealing body, an annular air chamber, a ring assembly, and a sealing assembly and is configured to reversibly attach to a hub assembly of a vehicle and configured to receive for reversable attachment a wheel of the vehicle. A sealing body disclosed herein rotates in unison with a hub assembly and wheel of a vehicle. A sealing body disclosed herein can further comprise a first annular fluid channel and a second annular fluid channel used to surround an annular air chamber to form a seal around the annular air chamber. An annular air chamber disclosed herein provides gaseous communication between the first air channel and the second air channel. A ring assembly disclosed herein remains in a stationary position in relation to a rotational movement of a hub assembly and wheel of a vehicle. In addition, a ring assembly disclosed herein can comprise a ring assembly air channel. A ring assembly disclosed herein can further comprise a lower fluid seal that forms a third annular fluid channel which can be in fluid communication with the first annular fluid channel and second annular fluid channel. A ring assembly disclosed herein can comprise an inner sealing ring, which in conjunction with the sealing body forms a first annular fluid channel. A sealing assembly disclosed herein can comprise an inner air seal and an outer air seal configured to form an annular air chamber as well as an upper fluid seal that forms a second annular fluid channel.

A ring housing hose can comprise a first fitting configured to reversibly and securely attached to a tire stem value of a tire and a second fitting configured to reversibly and securely attach to a housing attachment port on a ring housing disclosed herein. A ring assembly hose disclosed herein can comprise a first fitting configured to reversibly and securely attach to an attachment port on the ring assembly and a second fitting configured to reversibly and securely attach to a port of an air source. A ring housing hose and ring housing disclosed herein can comprise a first air channel providing gaseous communication between the tire stem valve and the annular air chamber. A ring assembly hose and the ring assembly disclosed herein can comprise a second air channel providing gaseous communication between the air source to the annular air chamber.

In yet other aspects of the present specification, a tire inflation system can comprise a sealing body, a sealing ring, a first annular fluid chamber, a second annular fluid chamber, and a third annular fluid chamber. A sealing body disclosed herein comprises a hub and an annular air channel formed concentrically around the hub, a first air passage arranged within the annular channel and formed through the sealing body. A sealing ring disclosed herein is arranged concentrically with and at least partially within the annular air channel and surrounding the hub, the inner ring being rotatably coupled with the sealing body through a bearing, a second fluid passage formed through the sealing ring. A first annular fluid chamber disclosed herein is at least partially delineated by a first annular seal, the annular channel, the sealing ring, and a second annular seal, the first annular seal arranged between the sealing ring and a first wall portion of the annular channel, the second annular seal arranged between the sealing ring and a second wall portion of the annular channel. A second annular fluid chamber disclosed herein is at least partially delineated by a third annular seal, the annular channel, the sealing ring, and a fourth annular seal, the third annular seal arranged between the sealing ring and a third wall portion of the annular channel, the fourth annular seal arranged between the sealing ring and a fourth wall portion of the annular channel. A third annular fluid chamber disclosed herein is situated between the first annular fluid chamber and the second annular fluid chamber and is at least partially defined between the second annular seal, the annular channel, the sealing ring, and the third annular seal. A third annular fluid chamber disclosed herein is configured to hold therewithin and transfer a fluid between the first fluid passage and the second fluid passage while the sealing ring is rotated about the sealing body.

Further aspects of the present specification disclose a centralized tire inflation system. A central tire inflation system comprises a tire inflation system disclosed herein, a control system, an operator control panel, and an air supply assembly.

### BRIEF DESCRIPTION OF THE DRAWINGS

The accompanying drawings, which are incorporated in and constitute a part of this specification, illustrate aspects of the disclosed subject matter in at least one of its exemplary embodiments, which are further defined in detail in the following description. Features, elements, and aspects of the disclosure are referenced by numerals with like numerals in different drawings representing the same, equivalent, or similar features, elements, or aspects, in accordance with one or more embodiments. The drawings are not necessarily to scale, emphasis instead being placed upon illustrating the principles herein described and provided by exemplary embodiments of the invention. In such drawings:

FIG. 1 is an outboard view of a tire inflation apparatus disclosed herein;

FIG. 2 is an inboard view of a tire inflation apparatus disclosed herein;

FIG. 3 is a side view of a tire inflation apparatus disclosed herein;

FIG. 4 is an exploded inboard perspective view of a tire inflation apparatus disclosed herein;

FIG. 5 is an inboard view of a sealing body disclosed herein;

FIG. 6 is a partial magnified cross-sectional view showing a portion of the sealing body of FIG. 5, taken at 6-6;

FIG. 7 is an inboard view of an inner sealing ring disclosed herein;

FIG. 8 is a partial magnified cross-sectional view showing a portion of the inner sealing ring of FIG. 7, taken at 8-8;

FIG. 9 is an inboard view of an annular bearing assembly disclosed herein;

FIG. 10 is a partial magnified cross-sectional view showing a portion of the annular bearing assembly of FIG. 9, taken at 10-10;

FIG. 11 is a partial magnified front view showing a portion of the annular bearing assembly of FIG. 9, taken at 11;

FIG. 12 is an inboard view of an outer sealing ring disclosed herein;

FIG. 13A is a partial magnified cross-sectional view showing a portion of the outer sealing ring of FIG. 12, taken at 13A-13A;

FIG. 13B is an enlarged cross-sectional view showing a portion of the outer sealing ring of FIG. 12, taken at 13B-13B;

FIG. 14 a partial magnified cross-sectional view showing a portion an inner sealing sleeve disclosed herein;

FIG. 15 is a partial magnified cross-sectional view showing a portion of the inner sealing sleeve of FIG. 14, taken at 15-15;

FIG. 16 is a partial magnified cross-sectional view of an inner air seal disclosed herein;

FIG. 17 is a partial magnified cross-sectional view of an outer air seal disclosed herein;

FIG. 18 is a partial magnified cross-sectional view of a lower fluid seal disclosed herein;

FIG. 19 is a partial magnified cross-sectional view of an upper fluid seal disclosed herein;

FIG. 20 is an assembled cross-sectional view of the tire inflation apparatus of FIG. 1, taken at 20-20;

FIG. 21 is a partial magnified cross-sectional view of the tire inflation apparatus of FIG. 20, taken at 21;

FIG. 22 is an exploded outboard perspective view of a tire inflation apparatus disclosed herein exploded from a wheel and hub assembly;

FIG. 23 is an outboard perspective view of a tire inflation apparatus disclosed herein installed between a wheel assembly and a hub assembly, with the wheel shown in partial cross-section; and

FIG. 24 is a top view of a centralized tire inflation system disclosed herein.

FIG. 25 is an exploded inboard perspective view of a tire inflation apparatus disclosed herein;

FIG. 26 is an inboard view of a sealing body disclosed herein;

FIG. 27 is a partial magnified cross-sectional view showing a portion of the sealing body of FIG. 26, taken at 27-27;

FIG. 28 is an inboard view of a combined sealing ring disclosed herein;

FIG. 29 is a partial magnified cross-sectional view showing a portion of the combined sealing ring of FIG. 28, taken at 28-28;

FIG. 30 is an outboard view of a combined sealing ring disclosed herein;

FIG. 31 is an inboard view of an outer sealing sleeve disclosed herein;

FIG. 32 is a partial magnified cross-sectional view showing a portion of the outer sealing sleeve of FIG. 31, taken at 32-32;

FIG. 33 is an inboard view of an outer retainer ring disclosed herein;

FIG. 34 is a partial magnified cross-sectional view showing a portion of the outer retainer ring of FIG. 33, taken at 34-34;

FIG. 35 is an inboard view of an inner retainer ring disclosed herein;

FIG. 36 is a partial magnified cross-sectional view showing a portion of the inner retainer ring of FIG. 35, taken at 36-36;

FIG. 37 is an assembled cross-sectional view of the tire inflation apparatus; and

FIG. 38 is a partial magnified cross-sectional view of the tire inflation apparatus of FIG. 37, taken at 38.

Listing of Reference Numbers Associated with Drawings

| Ref. No. | Element |
|---|---|
| 20 | Tire inflation apparatus |
| 22 | Wheel-facing direction or Outboard direction |
| 24 | Hub-facing direction or Inboard direction |
| 30 | Sealing body |
| 31 | Outboard body face |
| 31a | Outermost planar portion |
| 31b | Ramp portion |
| 31c | Innermost planar portion |
| 31d | Collar |
| 32 | Inboard body face |
| 33 | Outer side wall |
| 34 | Fluid port |
| 35 | Fluid port plug |
| 36 | Body hose attachment port |
| 37 | Outer retainer ring attachment point |
| 38 | Pressure relief valve port |
| 39 | Pressure relief valve |
| 40 | Sealing hub |
| 42 | Sealing hub bore |
| 43 | Inner retainer ring attachment point |
| 44 | Sealing hub stud hole |
| 46 | Sealing hub stud |
| 48 | Wheel stud hole |
| 49 | Sealing hub nut |
| 50 | Annular channel |
| 52 | Channel outer wall |
| 54 | Channel side wall |
| 54a | Outermost planar portion |
| 54b | Ramp portion |
| 54c | Innermost planar portion |
| 56 | Channel inner wall |
| 57 | Lower bearing assembly seat |
| 58 | Sealing sleeve seat |
| 59 | Space |
| 60 | Sealing body hose |
| 62 | First body hose fitting |
| 64 | Second body hose fitting |
| 66 | Body hose air channel |
| 70 | Sealing ring assembly |
| 72 | Rotating outer hub |
| 74 | Stationary inner hub |
| 80 | Inner sealing ring |
| 81 | Outboard inner ring face |
| 81a | Outermost planar portion |
| 81b | Ramp portion |
| 81c | Innermost planar portion |
| 82 | Inboard inner ring face |
| 84 | Outer wall |
| 85 | Inner wall |
| 86 | Inner ring hub opening |
| 88 | Inner sealing ring air channel |
| 88a | First opening |
| 88b | Second opening |
| 90 | Annular bearing assembly |
| 91 | Outboard bearing ring face |
| 92 | Inboard bearing ring face |
| 93 | Outer bearing ring |
| 93a | Outer bearing surface |
| 94 | Inner bearing ring |
| 94a | Inner bearing surface |
| 96 | Bearing hub opening |
| 97 | Ball bearing |
| 98 | Bearing fluid channel |
| 99 | Bearing ring stud |
| 100 | Outer sealing ring |
| 101 | Outboard outer ring face |
| 102 | Inboard outer ring face |
| 104 | Outer wall |
| 105 | Inner wall |
| 106 | Outer sealing ring hub opening |
| 108 | Upper bearing assembly seat |
| 110 | Outer sealing ring air channel |
| 110a | First opening |
| 110b | Second opening |
| 112 | Lower fluid seal seat |
| 114 | Fluid channel |
| 116 | Sealing ring air channel |
| 120 | Sealing ring hose |
| 122 | First ring hose fitting |
| 124 | Second ring hose fitting |
| 126 | Ring hose air channel |
| 128 | Ring hose bracket |
| 129 | Ring hose bracket channel |
| 130 | Inner sealing sleeve |
| 131 | Outboard inner sealing sleeve face |
| 132 | Inboard inner sealing sleeve face |
| 134 | Outer wall of inner sealing sleeve |
| 135 | Inner wall of inner sealing sleeve |
| 136 | Inner sealing sleeve hub opening |
| 138 | Inner sealing sleeve seat |
| 140 | Inner air seal |
| 141 | Outboard seal face |
| 142 | Inboard seal face |
| 144 | Outer seal wall |
| 145 | Inner seal wall |
| 146 | Inner seal hub opening |
| 147 | Inner seal air channel |
| 148 | Inner seal spring |
| 150 | Outer air seal |
| 151 | Outboard seal face |
| 152 | Inboard seal face |
| 154 | Outer seal wall |
| 155 | Inner seal wall |
| 156 | Outer seal hub opening |
| 157 | Outer seal air channel |
| 158 | Outer seal spring |
| 160 | Lower fluid seal |
| 161 | Outboard seal face |
| 162 | Inboard seal face |
| 164 | Outer seal wall |
| 165 | Inner seal wall |
| 166 | Lower seal hub opening |
| 167 | Lower seal fluid channel |
| 168 | Lower seal spring |
| 170 | Upper fluid seal |
| 171 | Outboard seal face |
| 172 | Inboard seal face |
| 174 | Outer seal wall |
| 175 | Inner seal wall |
| 176 | Upper seal hub opening |
| 177 | Upper seal fluid channel |
| 178 | Upper seal spring |
| 180 | Annular air chamber |
| 182 | First annular fluid chamber |
| 184 | Second annular fluid chamber |
| 186 | Third annular fluid chamber |
| 200 | Hub assembly |
| 210 | Rotor |
| 212 | Brake disc |
| 214 | Wheel hub |
| 216 | Hub bore |
| 218 | Wheel stud |
| 220 | Bearing assembly |
| 222 | Annular lip |
| 230 | Suspension knuckle |
| 232 | Attachment points |
| 240 | Brake caliper assembly |
| 300 | Wheel |
| 310 | Wheel dish |
| 312 | Center cap |
| 314 | Wheel bore |
| 316 | Wheel stud holes |
| 318 | Spoke |
| 320 | Barrel |
| 322 | Outer rim |
| 324 | Inner rim |
| 326 | Valve stem hole |
| 328 | Wheel stud nut |
| 400 | Axle assembly |
| 402 | Drive Shaft |
| 404 | Stub axle |
| 500 | Centralized Tire Inflation System |
| 510 | Control system |
| 512 | Electronic control unit |
| 514 | Pneumatic control unit |
| 516 | Electronic harness |
| 520 | Sensor |
| 522 | Pressure sensor |
| 524 | Air flow sensor |
| 526 | Speed sensor |
| 528 | Load sensor |
| 530 | Operator control panel |
| 532 | Pressure adjustment knob |
| 540 | Air supply assembly |
| 542 | Air source |
| 544 | Tire hose assembly |
| 546 | Air hoses |
| 552 | Pressure protection valve |
| 554 | Quick release valve |
| 556 | Wheel valve |
| 600 | Combined sealing ring |
| 601 | Outboard outer ring face |
| 602 | Inboard outer ring face |
| 604 | Outer wall |
| 605 | Inner wall |
| 606 | Combined sealing ring hub opening |
| 607 | Outer sealing sleeve seat |
| 608 | Upper bearing assembly seat |
| 609 | Lower fluid seal seat |
| 610 | Combined sealing ring air channel |
| 610a | First opening |
| 610b | Second opening |
| 612 | Bracker attachment points |
| 614 | Fluid channel |
| 614a | First opening |
| 614b | Second opening |
| 616 | Washer seat |
| 617 | Screw |
| 618 | Washer |
| 620 | Caliper Bracket |
| 622 | First bracket screw |
| 624 | Caliper bracket screw |
| 630 | Outer sealing sleeve |
| 631 | Outboard outer sealing sleeve face |
| 632 | Inboard outer sealing sleeve face |
| 634 | Outer wall of outer sealing sleeve |
| 635 | Inner wall of outer sealing sleeve |
| 636 | Outer sealing sleeve hub opening |
| 638 | Outer sealing sleeve seat |
| 639 | Outer sealing sleeve channels |
| 680 | Outer retainer ring |
| 681 | Outboard outer retainer ring face |
| 682 | Inboard outer retainer ring face |
| 684 | Outer wall of outer retainer ring |
| 685 | Inner wall of outer retainer ring |
| 686 | Outer retainer ring hub opening |
| 687 | Sealing body through hole |
| 688 | Screw |
| 690 | Inner retainer ring |
| 691 | Outboard inner retainer ring face |
| 692 | Inboard inner retainer ring face |
| 694 | Outer wall of inner retainer ring |
| 695 | Inner wall of inner retainer ring |
| 696 | Inner retainer ring hub opening |
| 697 | Sealing hub through hole |
| 698 | Screw |
| 699 | Inner sealing sleeve seat |

### DETAILED DESCRIPTION

The present specification discloses a tire inflation apparatus and a centralized tire inflation system. The disclosed apparatus and system improves tire life, ensures operational efficiency by reducing downtime, peak performance across all terrain in all weathers, and operator comfort, and reduces fuel consumption, wheel slip due to incorrect tire pressures, vehicle maintenance costs, impact sustained by road surface, and risk of vehicle breakdown or immobilization.

The present apparatus and centralized tire inflation system advantageously permits an operator to inflate and deflate a tire of a vehicle while the vehicle is moving by providing a rotating annular fluid connection between a wheel and an air supply assembly positioned within the vehicle. The overall geometry of the present tire inflation apparatus is a relatively thin disc at the hub portion surrounded by an annular fluid connection; and, much like a wheel spacer, is positioned between a hub assembly and a wheel assembly of a vehicle. In some embodiments, the overall geometry of the present tire inflation apparatus comprises a relatively thin disc that causes minimal change to offset of the wheel relative to a hub assembly. In other embodiments, where the present tire inflation apparatus also functions as a spacer, a thicker disc with a specific offset distance is used.

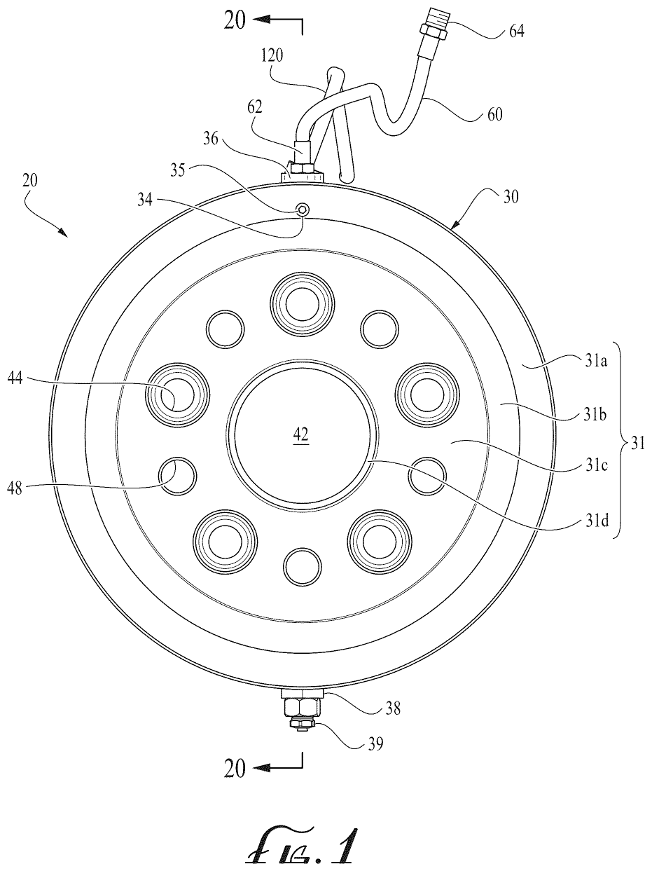

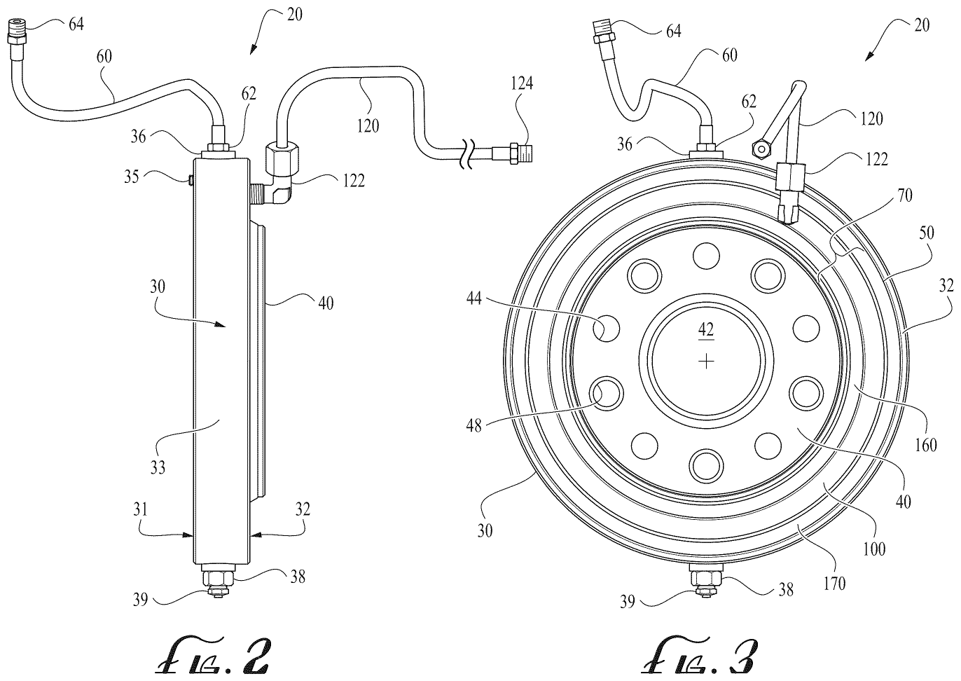

FIGS. 1-4 & 25 illustrates components of an example embodiment of tire inflation apparatus 20. In some embodiments, tire inflation apparatus 20 comprises sealing body 30, sealing body hose 60, and sealing ring hose 120. Sealing body 30 acts as a base upon which the other components are mounted thereto, which are configured to either rotate with sealing body 30 or remain relatively stationary relative to sealing body 30. Sealing body 30 is disc-shaped housing and comprises an outboard body face 31, an inboard face 32, and an outer side wall 33.

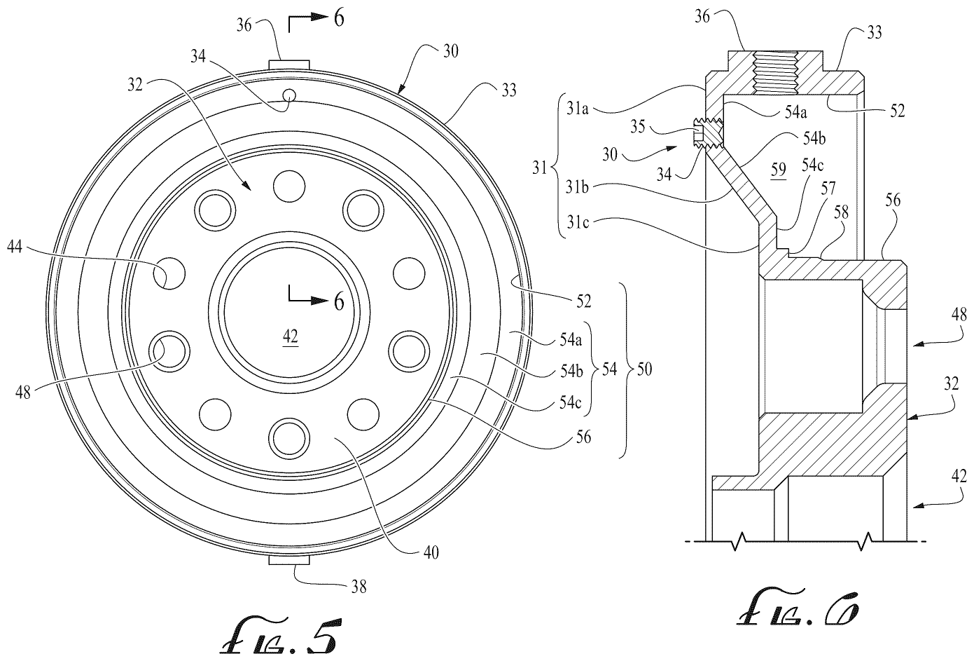

As shown in FIGS. 6 & 27, outboard body face 31 can comprise three annular portions and a collar 31d that encircles sealing hub bore 42. The three annular portions include an outermost planar portion 31a encircling an outer perimeter sealing body 30 and being perpendicular to the axis of rotation closer to wheel-facing direction 22, an innermost planar portion 31c encircling collar 31d and being perpendicular to the axis of rotation and stepped closer to a hub-facing direction 24, and a planar ramp portion 31b transverse to the axis of rotation and connecting outermost planar portion 31a and innermost planar portion 31c. This arrangement provides an interface for receiving a wheel within a depression formed by planar ramp portion 31b and innermost planar portion 31c of outboard body face 31 to facilitate attachment of a wheel to tire inflation apparatus 20. Referring to FIGS. 1, 2, 5, 6, 26 & 27, outboard body face 31 also comprises a fluid port 34 having a fluid port plug 35 located on outermost planar portion 31a and is used to introduce oil or other lubricating fluid into fluid channels located within tire inflation apparatus 20.

As shown in FIGS. 1-6, 26 & 27, outer side wall 33 comprises a body hose attachment port 36 and a pressure relief valve port 38. Body hose attachment port 36 is a threaded through hole configured to receive a first body hose fitting 62 of sealing body hose 60 and is used to attach sealing body hose 60 to sealing body 30. Pressure relief valve port 38 is a threaded through hole configured to receive a pressure relief valve 39 that is used vent air or other inflation gas without risking damage to the hub or rear-axle seals.

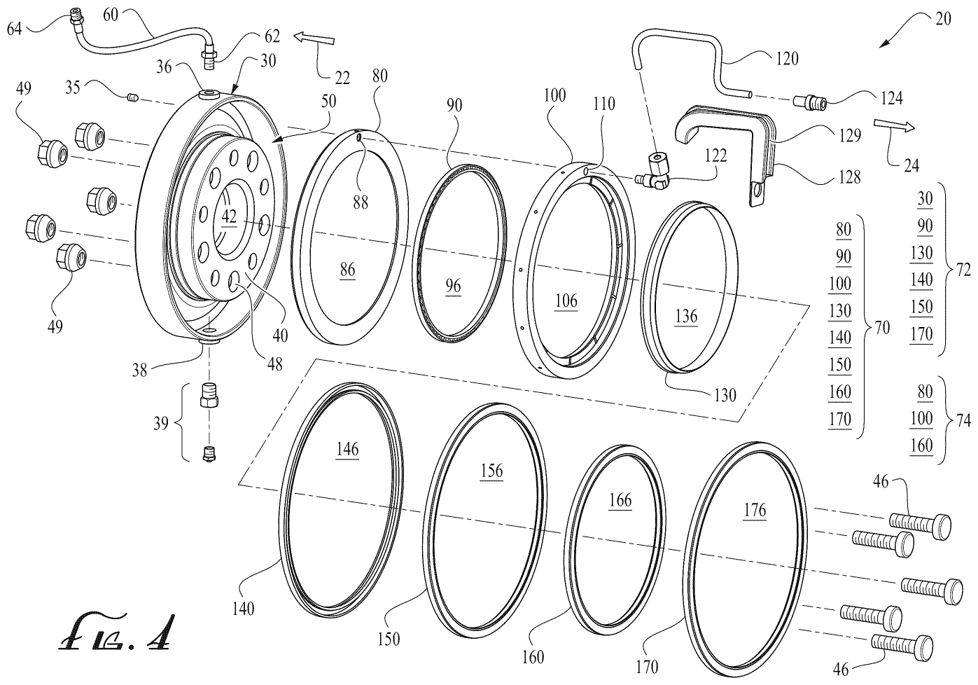

Referring to FIGS. 4-6, 26 & 27, inboard body face 32 comprises a sealing hub 40 and an annular channel 50. Sealing hub 40 is centrally located with annular channel 50 completely surrounding sealing hub 40. Sealing hub 40 interfaces with a hub assembly of a vehicle and facilitates attachment of tire inflation apparatus 20 to the hub assembly. The moving components and air channels of tire inflation apparatus 20 are arranged annularly about sealing hub 40 to form toroid-like arrangement. Annular channel 50 serves as a housing for a sealing ring assembly 70 and in conjunction with sealing ring assembly 70 forms an air channel that enable a tire to be inflated.

As shown in FIGS. 5 & 26, sealing hub 40 comprises sealing hub bore 42, one or more sealing hub stud holes 44, one or more sealing hub studs 46, and one or more wheel stud holes 48. Sealing hub bore 42 is centrally located in sealing hub 40 and is concentric with aligned with the axis of rotation about which a hub assembly and a wheel rotate. Sealing hub bore 42 is configured to receive a stub axle of an axile assembly. Each of the one or more sealing hub stud holes 44 is a through hole configured to receive one of the one or more sealing hub studs 46 in a manner where each of the one or more sealing hub studs 46 perpendicularly projects from sealing hub 40 on outboard body face 31 of sealing body 30. During installation, one of one or more sealing hub nuts 49 is securely affixed to each of the one or more sealing hub studs 46. One securely affixed, each of the one or more sealing hub stud holes 44 is equally space around the periphery of sealing hub bore 42 and positioned in a manner that aligns each of the one or more sealing hub studs 46 with one of the one or more wheel stud holes of a wheel. Each of the one or more wheel stud holes 48 is positioned in between a pair of one or more sealing hub stud holes 44, and each is configured to receive one of the one or more wheel studs of a hub assembly.

As shown in FIGS. 5, 6, 26 & 27, annular channel 50 is formed about and completely surrounds sealing hub 40 and comprises a channel outer wall 52, a channel side wall 54, and a channel inner wall 56. Channel outer wall 52 is the outermost (or largest diameter) annular wall of annular channel 50 and is opposite channel inner wall 56, which has a smaller annular diameter than channel outer wall 52. Channel side wall 54 spans between channel outer wall 52 and channel inner wall 56, thereby defining a space 58 configured to house sealing ring assembly 70. Referring to FIG. 6, channel outer wall 52, Channel side wall 54, and channel inner wall 56 define a space 59 of annular channel 50. Space 59 has a cross-sectional shape that is generally rectangular, although there are step-like seats configured to receive components of ring assembly 70.

In some embodiments, channel side wall 54 can comprise an outermost planar portion 54a encircling an outer perimeter of annular channel 50 and being perpendicular to the axis of rotation closer to wheel-facing direction 22, an innermost planar portion 54c encircling hub bore 40 and being perpendicular to the axis of rotation and stepped closer to a hub-facing direction 24, and a planar ramp portion 54b transverse to the axis of rotation and connecting outermost planar portion 54a and innermost planar portion 54c. In some embodiments, channel inner wall 56 can include steps that correspond to a lower bearing seat 57 for a bearing assembly and a sealing sleeve seat 57 for a sealing sleeve.

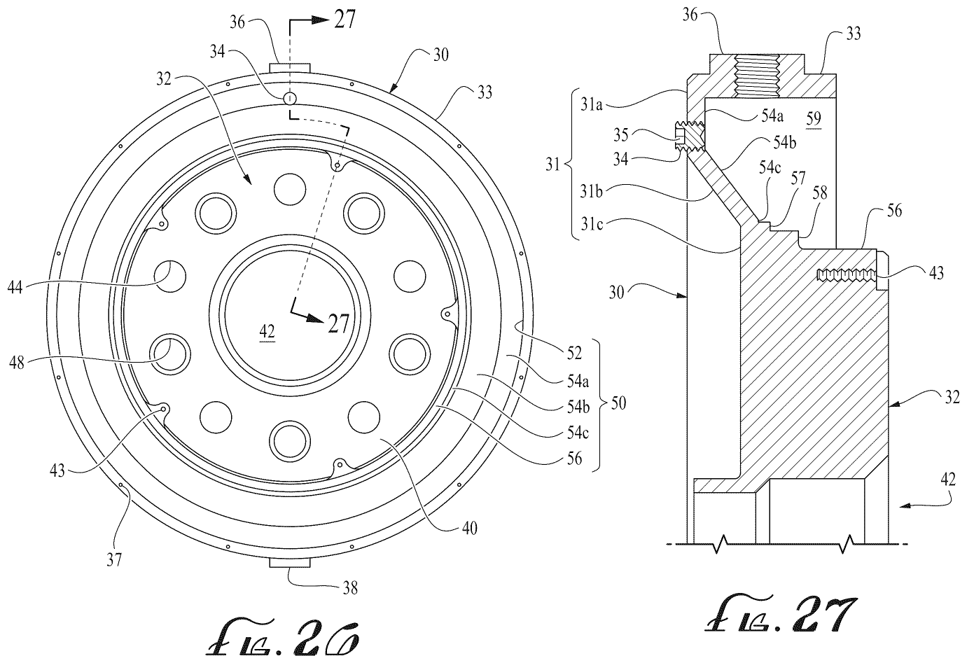

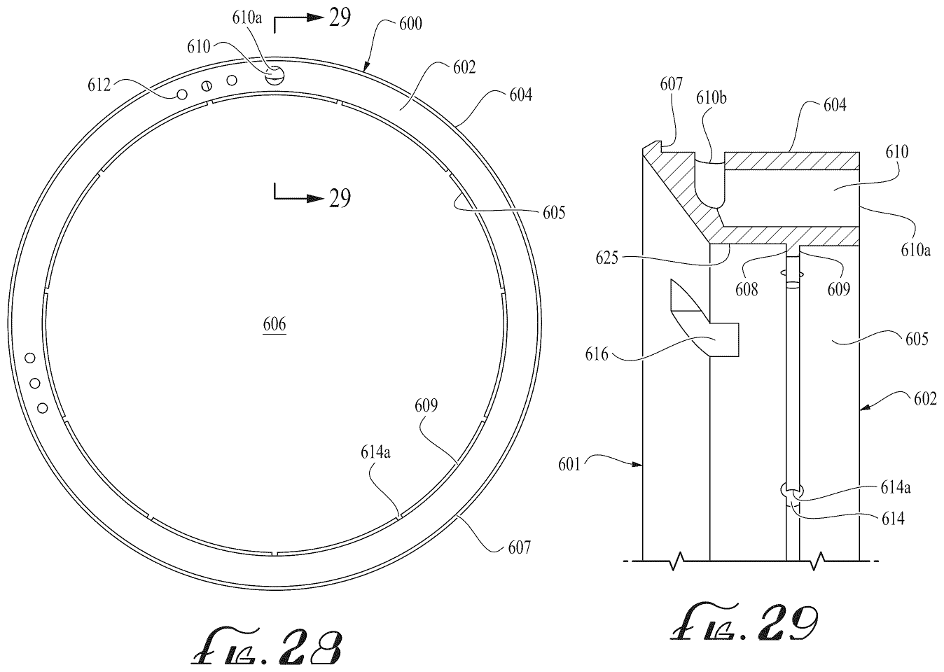

As best seen in FIGS. 25-27, one or more outer retainer ring attachment points 37 are positioned around the periphery of inboard body face 32 of outer side wall 33. In some embodiments, one or more outer retainer ring attachment points 37 are each a blind hole threaded to receive a screw 688 which is used to secure an outer retainer ring 680 to outer side wall 33 of sealing body 30. In addition, one or more inner retainer ring attachment points 43 are positioned around the periphery of sealing hub 40 adjacent to channel inner wall 56. In some embodiments, one or more inner retainer ring attachment points 43 are each a depression in sealing hub 40 and having a blind hole threaded to receive a screw 698 which is used to secure an inner retainer ring 690 to sealing hub 40 of sealing body 30.

Referring to FIGS. 1-4, sealing body hose 60 is typically a tubular structure comprising a first end, a second end, and an air channel 66 configured to allow gaseous communication therethrough. Sealing body hose 60 has a first fitting 62 at its first end and a second fitting 64 at its second end. First fitting 62 is configured to securely connect to body hose attachment port 36 located on outer side wall 33 of sealing body 30. Second fitting 64 is configured to securely attached to a tire valve stem of a tire. Upon assembly sealing body hose 60 forms a contiguous air passage that enables gaseous communication therethrough and enables air or other gas to enter into a tire via tire inflation apparatus 20 cause inflation of the tire or enables the release of air or other gas from a tire via pressure relief valve 39 of tire inflation apparatus 20 to cause deflation of the tire.

Referring to FIGS. 1-4, sealing ring hose 120 is typically a tubular structure comprising a first end, a second end, and an air channel 126 configured to allow gaseous communication therethrough. Sealing ring hose 120 has a first fitting 122 at its first end and a second fitting 124 at its second end. First fitting 122 is configured to securely attached to an opening located in a inboard outer ring face 102 of an outer sealing ring 100. Second fitting 124 is configured to securely attached to an air port of an air supply assembly. Upon assembly ring hose 120 forms a contiguous air passage that enables gaseous communication therethrough and enables air or other gas to enter into a tire via tire inflation apparatus 20 cause inflation of the tire.

In some embodiments, and referring to FIG. 4, sealing ring assembly 70 comprises an inner sealing ring 80, an annular bearing assembly 90, outer sealing ring 100, an inner sealing sleeve 130, an inner air seal 140, an outer air seal 150, a lower fluid seal 160, an upper fluid seal 170. In some embodiments, and referring to FIG. 25, sealing ring assembly 70 comprises an combined sealing ring 600, annular bearing assembly 90, inner sealing sleeve 130, inner air seal 140, outer air seal 150, lower fluid seal 160, upper fluid seal 170, an outer sealing sleeve 630, an outer retainer ring 680, and an inner retainer ring 690.

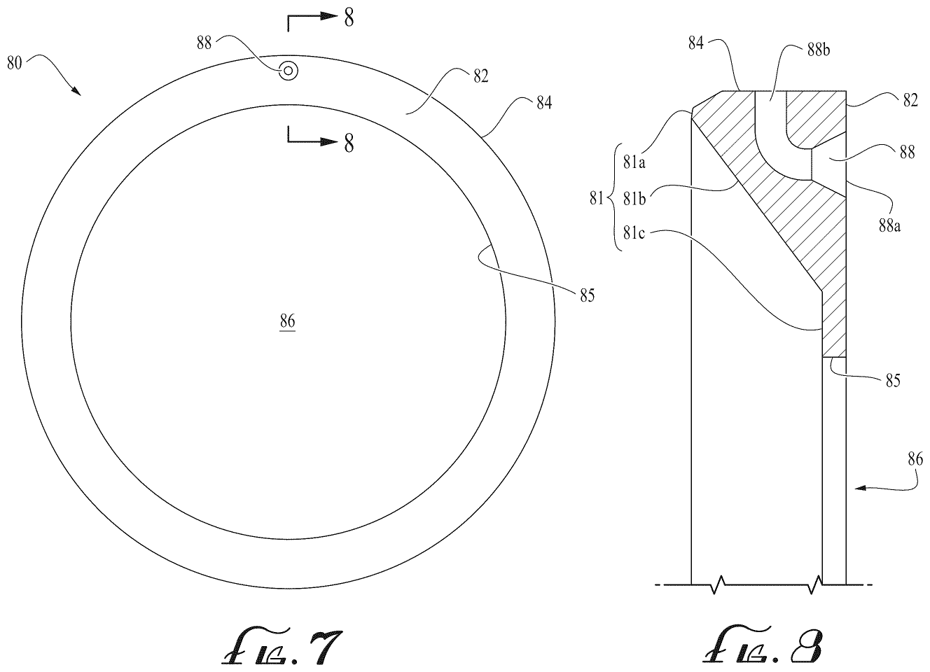

Referring to FIGS. 4, 7 & 8, inner sealing ring 80 of sealing ring assembly 70 is an annular ring defining hub opening 86 of sufficient internal diameter to receive therewithin sealing hub 40 of sealing body 30. Inner sealing ring 80 comprises an outboard inner ring face 81 opposite an inboard inner ring face 82 and having a thickness defined by an outer wall 84 and an inner wall 85. In some embodiments, and as shown in FIG. 8, outboard inner ring face 81 can comprise an outermost planar portion 81a encircling an outer perimeter of sealing body 30 and being perpendicular to the axis of rotation closer to wheel-facing direction 22, an innermost planar portion 81c encircling sealing hub bore 42 and being perpendicular to the axis of rotation and stepped closer to a hub-facing direction 24, and a planar ramp portion 81b transverse to the axis of rotation and connecting outermost planar portion 81a and innermost planar portion 81c. Inner sealing ring 80 also comprises an inner sealing ring air channel 88, a passageway that completely traverses inner sealing ring 80 and is configured to allows gaseous communication therethrough. Inner sealing ring air channel 88 has a first opening 88a located in inboard inner ring face 82 and a second opening 88b located in outer wall 84 of inner sealing ring 80.

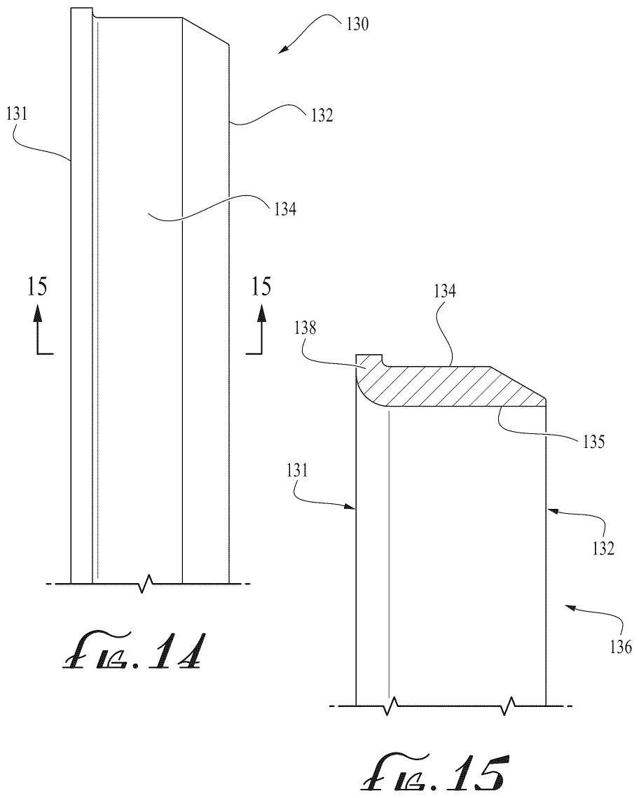

Referring to FIGS. 4, 12, 13A, &13B, outer sealing ring 100 of sealing ring assembly 70 is an annular ring defining outer sealing ring hub opening 106 of sufficient internal diameter to receive therewithin sealing hub 40 of sealing body 30. Outer sealing ring 100 comprises outboard outer ring face 101 opposite an inboard outer ring face 102 and having a thickness defined by an outer wall 104 and an inner wall 105. Outer sealing ring 100 also comprises an outer sealing ring air channel 110, a passageway that completely traverses outer sealing ring 100 and is configured to allows gaseous communication therethrough. Outer sealing ring air channel 110 has a first opening 110a located in inboard outer ring face 102 and a second opening 110b located in outboard outer ring face 101. Outer sealing ring air channel 110 has a threaded portion at second opening located in outboard outer ring face 101 configured to securely receive sealing ring hose 120 via a first ring hose fitting 122. Outer sealing ring 100 also includes a lower fluid seal seat 112 and is configured to receive lower fluid seal 160 as well as a series of fluid channels 114, through holes that completely traverses outer wall 104 and inner wall 105 of outer sealing ring 100 and is configured to allows fluid communication therethrough. In some embodiments, inner wall 105 can include a step that correspond to an upper bearing seat 108 for a bearing assembly. Inner sealing ring 80 and outer sealing ring 100 are securely attached to each other at their respective mating faces, namely inboard inner ring face 82 and outboard outer ring face 101. In some embodiments, inboard inner ring face 82 and outboard outer ring face 101 are securely attached to each other by, e.g., press-fit, fastening with bolts, pegs, rivets, or screws, brazing with a filler metal, soldering, welding, affixing with an adhesive, or other attachment means that securely join inboard inner ring face 82 and outboard outer ring face 101. In some embodiments, inboard inner ring face 82 and outboard outer ring face 101 a manufactured as a single piece, thereby precluding the need for an attachment means that securely join inboard inner ring face 82 and outboard outer ring face 101.

Referring to FIGS. 25 & 28-30, combined sealing ring 600, of sealing ring assembly 70 is an annular ring defining outer sealing ring hub opening 606 of sufficient internal diameter to receive therewithin sealing hub 40 of sealing body 30. Combined sealing ring 600 comprises outboard outer ring face 601 opposite an inboard outer ring face 602 and having a thickness defined by an outer wall 604 and an inner wall 605. Combined sealing ring 600 also comprises a combined sealing ring air channel 610, a passageway that traverses combined sealing ring 600 and is configured to allows gaseous communication therethrough. Combined sealing ring air channel 610 has a first opening 610a located in inboard outer ring face 602 and a second opening 610b located in outer wall 604. First opening 610a is circular in shape and has a threaded portion configured to securely receive sealing ring hose 120 via a first ring hose fitting 122. Second opening 610b is is a trough-shaped opening configured to align with a plurality outer sealing sleeve channels 639 of outer sealing sleeve 630. Outer wall 604 of combined sealing ring 600 includes an outer sealing sleeve seat 608 on an edge of its outboard outer ring face 601 configured to receive outer sealing sleeve 630. Inner wall 605 of combined sealing ring 600 includes an upper bearing assembly seat 608 on its outboard outer ring face 601 configured to receive annular bearing assembly 90 and a lower fluid seal seat 609 on its inboard outer ring face 602 configured to receive lower fluid seal 160. Combined sealing ring 600 further comprises a series of fluid channels 614, through holes that completely traverses outer wall 604 and inner wall 605 of combined sealing ring 600 and is configured to allows fluid communication therethrough.

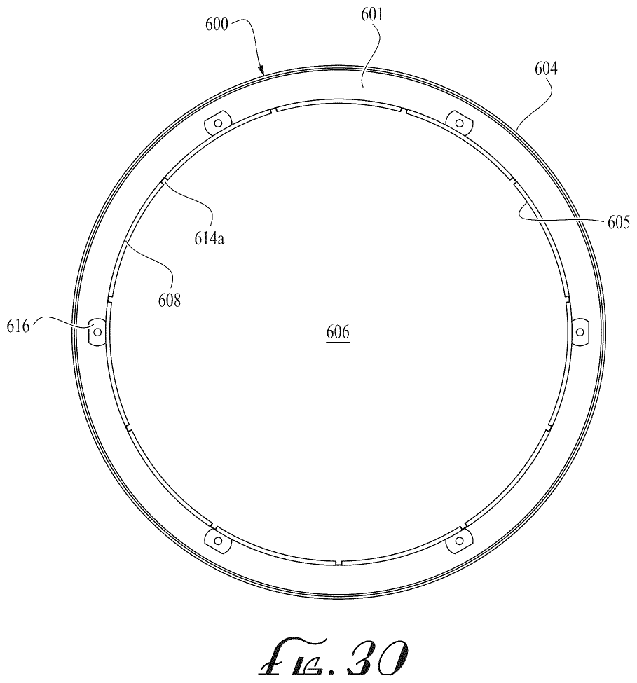

As shown in FIG. 28, inboard outer ring face 602 also includes one or more bracket attachment points 612. Each bracket attachment points 612 can include one or more blind holes threaded to receive a first bracket screw 622 which is used to secure a caliper bracket 620 to inboard outer ring face 602 of combined sealing ring 600. Besides through holes configured to receive first bracket screws 622, one or more caliper brackets 620 also comprises a through hole configured to receive a caliper bracket screw 624. One or more caliper brackets 620 are used to assist in securing inflation tire apparatus 20 to a brake caliper assembly of a hub assembly disclosed herein. As shown in FIGS. 29 & 30, outboard outer ring face 601 includes a plurality washer seats 616 each washer seat 616 having a blind hole threaded to receive a screw and configured to receive.

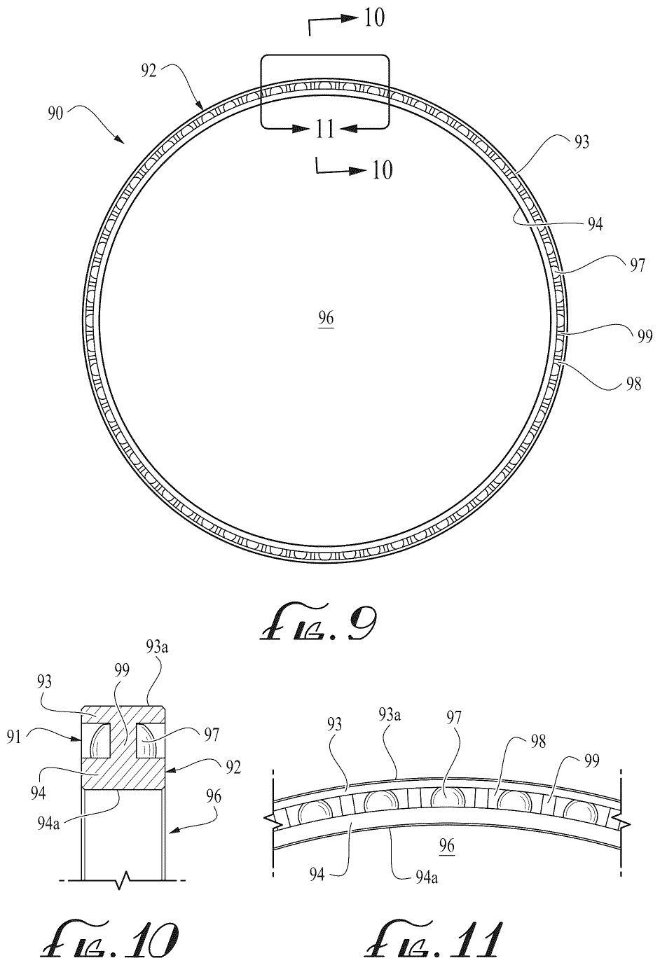

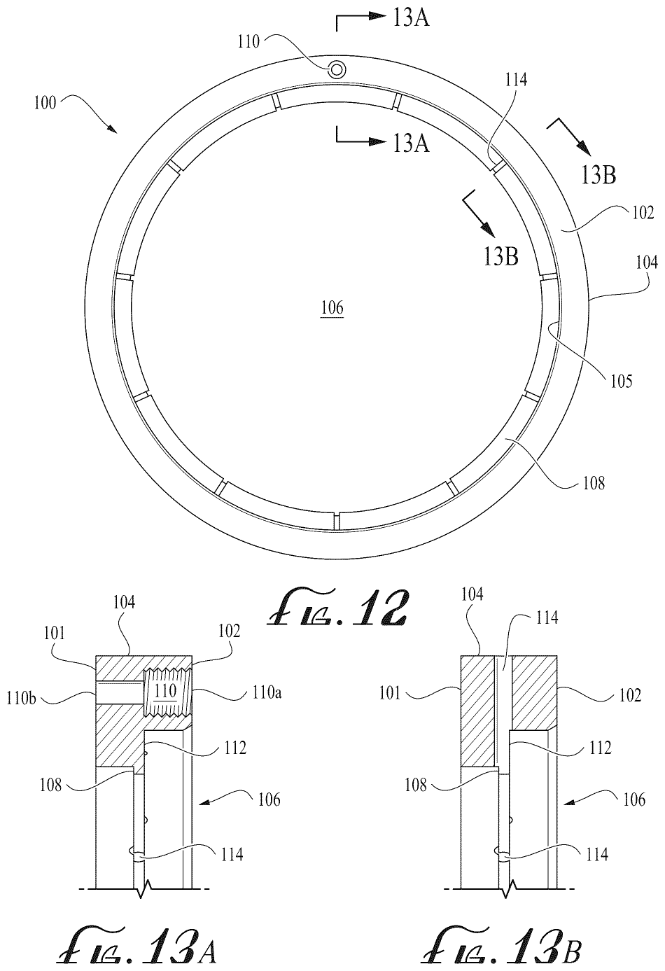

Referring to FIGS. 4, 9-11 & 25, annular bearing assembly 90 of sealing ring assembly 70 is an annular ring defining a bearing hub opening 96 of sufficient internal diameter to receive therewithin sealing hub 40 of sealing body 30. Annular bearing assembly 90 is smaller in overall diameter than inner sealing ring 80 and outer sealing ring 100 as well as combined sealing ring 600. Annular bearing assembly 90 has an outboard bearing ring face 91 opposite outboard bearing ring face 92 and comprises an outer bearing ring 93 having an outer bearing surface 93a and an inner bearing ring 94 having an inner bearing surface 94a. Annular bearing assembly 90 houses ball bearings 97 which are trapped between outer and inner bearing rings 93, 94. Annular bearing assembly 90 enables smooth and independent rotation of attached inner sealing ring 80 and outer sealing ring 100 or combined sealing ring 600 relative to sealing body 30, or vice versa. Each ball bearing 97 is separated by a bearing ring stud 99 and a space formed between each ball bearing 97 and bearing ring stud 99 defines a bearing fluid channel 98.

Referring to FIGS. 4, 14, 15 & 25, inner sealing sleeve 130 of sealing ring assembly 70 is an annular ring defining an inner sealing sleeve hub opening 136 of sufficient internal diameter to receive therewithin sealing hub 40 of sealing body 30. Inner sealing sleeve 130 comprises an outboard sealing sleeve face 131 opposite an inboard sealing sleeve face 132 and having a thickness defined by an outer wall 134 of inner sealing sleeve 130 and an inner wall 135 of inner sealing sleeve 130. Outer wall 134 comprises an inner sealing sleeve seat 138 configured to form a seal with lower fluid seal 160. As inner sealing sleeve 130 participates in securing annular bearing assembly 90 in place when assembled, the tolerance of inner wall 135 of inner sealing sleeve 130 and channel inner wall 56 of annular channel 50 should be a tight fit that prevents movement of these two parts with respect to each other.

Referring to FIGS. 25, 31 & 32, outer sealing sleeve 630 of sealing ring assembly 70 is an annular ring defining an outer sealing sleeve hub opening 636 of sufficient internal diameter to receive therewithin combined sealing ring 630. Outer sealing sleeve 630 comprises an outboard sealing sleeve face 631 opposite an inboard sealing sleeve face 632 and having a thickness defined by an outer wall 634 of outer sealing sleeve 630 and an inner wall 635 of inner sealing sleeve 630. Outer wall 634 comprises an outer sealing sleeve seat 638 which participates in securing inner air seal 140, outer air seal 150, and upper fluid seal 170 in place within annular channel 50 of sealing body 30. Outer sealing sleeve 630 comprises plurality outer sealing sleeve channels 639, a series of through holes that completely traverse outer sealing sleeve 630 from outer wall 634 to inner wall 635. Plurality outer sealing sleeve channels 639 aligns with combined sealing ring air channel 610 of combined sealing ring 600 and enable gaseous communication between combined sealing ring air channel 610 and an annular air chamber 180. As outer sealing sleeve 630 participates in securing inner air seal 140, outer air seal 150, and upper fluid seal 170 in place when assembled, the tolerance of inner wall 635 of outer sealing sleeve 630 and outer wall 604 of combined sealing ring 600 should be a tight fit that prevents movement of these two parts with respect to each other.

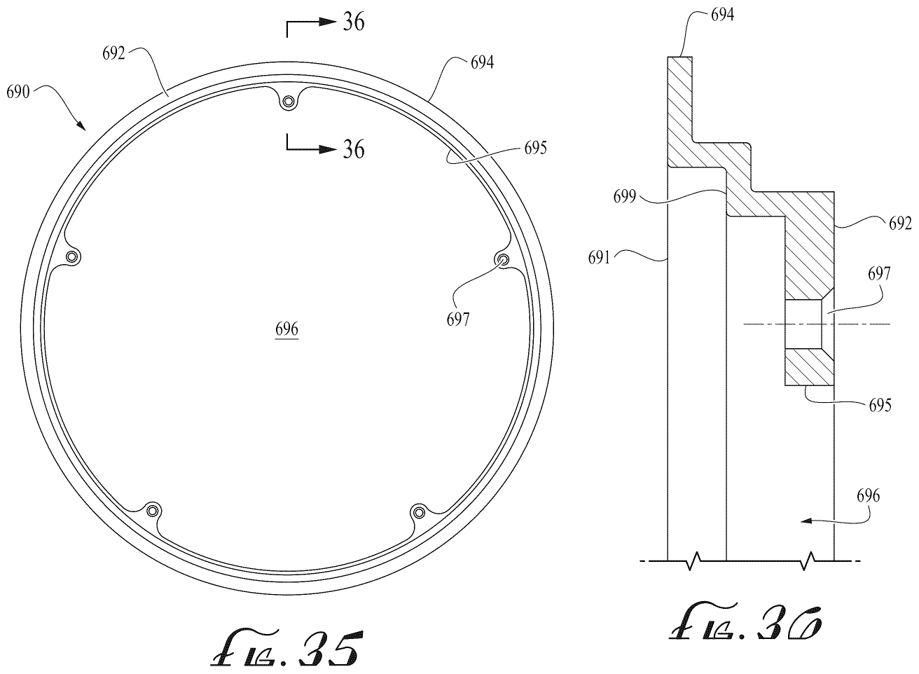

Referring to FIGS. 25, 33 & 34, outer retainer ring 680 of sealing ring assembly 70 is an annular ring defining an outer retainer ring hub opening 686 of sufficient internal diameter to receive therewithin combined sealing ring 600, outer sealing sleeve 630, and sealing hub 40 of sealing body 30. In addition, the outer diameter of outer retainer ring 680 is identical or substantially similar to the outer diameter of sealing body 30 so that when assembled outer side wall 33 of sealing body 30 and outer diameter of outer retainer ring 680 are flush. Outer retainer ring 680 comprises an outboard retainer ring face 681 opposite an inboard retainer ring face 682 and having a thickness defined by an outer wall 684 of outer retainer ring 680 and an inner wall 685 of outer retainer ring 680. Outer retainer ring 680 comprises a plurality sealing body through holes 688, a series of through holes that completely traverse outer retainer ring 680 from outboard retainer ring face 681 to inboard retainer ring face 682. Each sealing body through hole 687 is positioned to align each outer retainer ring attachment point 37 so as to enable screw 688 to be inserted though sealing body through hole 687 and threadably secured to outer retainer ring attachment point 37, thereby securing outer retainer ring 680 to outer side wall 33 of sealing body 30.

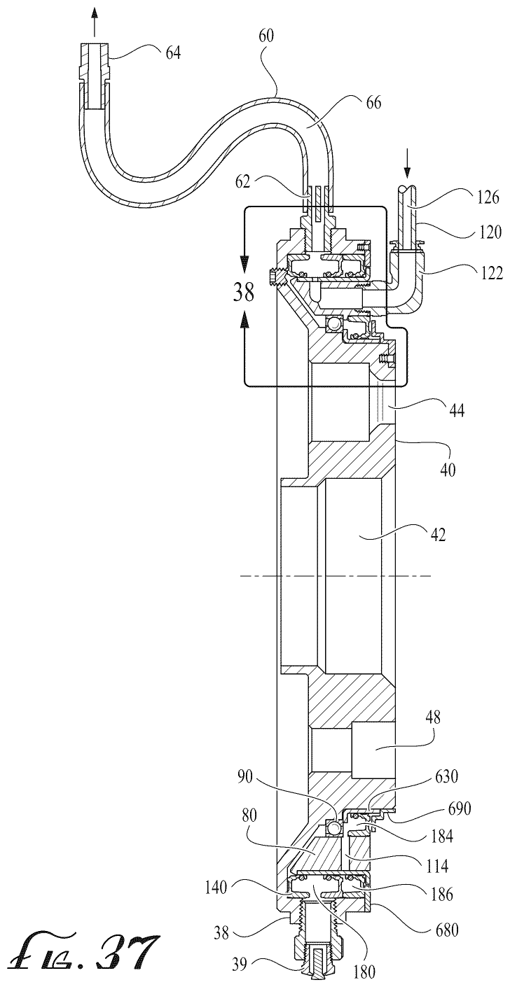

Referring to FIGS. 25, 35 & 36, inner retainer ring 690 of sealing ring assembly 70 is an annular ring defining an inner retainer ring hub opening 696 of sufficient internal diameter to receive therewithin sealing hub 40 of sealing body 30. Inner retainer ring 690 comprises an outboard retainer ring face 691 opposite an inboard retainer ring face 692 and having a thickness defined by an outer wall 694 of inner retainer ring 690 and an inner wall 695 of inner retainer ring 690. Inner retainer ring 690 comprises a plurality sealing hub attachment points 697, a series of tabs containing a through hole that extend perpendicularly from inner wall 695. Each sealing hub attachment point 697 is positioned to align with each inner retainer ring attachment point 43 so as to enable screw 698 to be inserted though sealing hub through hole of sealing hub attachment point 697 and threadably secured into threaded blind hole of inner retainer ring attachment point 43, thereby securing inner retainer ring 690 to sealing hub 40 of sealing body 30. Inner retainer ring 690 also comprises an inner sealing sleeve seat 699 which, when assembled, abuts edge of inboard inner sealing sleeve face 132 of inner sealing sleeve 130 and assists in securing inner sealing sleeve 130 to sealing hub 40.

As shown in FIG. 4, sealing ring assembly 70 also comprises four annular seals. In some embodiments, annular seals disclosed herein are pressurized seals and can be a commercially available spring-loaded, single-lip rotary shaft seal (American High Performance Seals).

Referring to FIGS. 4 & 16, inner air seal 140 is an annular ring defining an inner seal hub opening 146 of sufficient internal diameter to receive therewithin sealing hub 40 of sealing body 30. Inner air seal 140 comprises an outboard seal face 141 opposite an inboard seal face 142 and having a thickness defined by an outer seal wall 144 and an inner seal wall 145. An inner seal spring 148 is located in inner seal wall 145. Inboard seal face 142 comprises an inner seal air channel 147 that participates in forming an annular air chamber 180 when tire inflation apparatus 20 is assembled.

Referring to FIGS. 4 & 17, outer air seal 150 is an annular ring defining an outer seal hub opening 156 of sufficient internal diameter to receive therewithin sealing hub 40 of sealing body 30. Outer air seal 150 comprises an outboard seal face 151 opposite an inboard seal face 152 and having a thickness defined by an outer seal wall 154 and an inner seal wall 155. An outer seal spring 158 is located in inner seal wall 155. Outboard seal face 151 comprises an outer seal air channel 157 that participates in forming annular air chamber 180 when tire inflation apparatus 20 is assembled.

Referring to FIGS. 4 & 18, lower fluid seal 160 is an annular ring defining a lower seal hub opening 166 of sufficient internal diameter to receive therewithin sealing hub 40 of sealing body 30. Lower fluid seal 160 comprises an outboard seal face 161 opposite an inboard seal face 162 and having a thickness defined by an outer seal wall 164 and an inner seal wall 165. A lower seal spring 168 is located in inner seal wall 165. Outboard seal face 161 comprises a lower seal fluid channel 167 that participates in forming a third annular fluid chamber 186 when tire inflation apparatus 20 is assembled.

Referring to FIGS. 4 & 19, upper fluid seal 170 is an annular ring defining an upper seal hub opening 176 of sufficient internal diameter to receive therewithin sealing hub 40 of sealing body 30. Upper fluid seal 170 comprises an outboard seal face 171 opposite an inboard seal face 172 and having a thickness defined by an outer seal wall 174 and an inner seal wall 175. An upper seal spring 178 is located in inner seal wall 175. Outboard seal face 171 comprises an upper seal fluid channel 177 that participates in forming a second annular fluid chamber 184 when tire inflation apparatus 20 is assembled.

FIGS. 1-3, 20, 21, 37 & 38, illustrate an assembled tire inflation apparatus 20. In embodiments where tire inflation apparatus 20 comprises inner sealing ring 80 and outer sealing ring 100, and as best seen in FIGS. 4, 6, 8, & 21, inner sealing ring 80 is fitted into annual channel 50 of sealing body 30 in a manner where first annular fluid chamber 182 is formed by a gap between ramp portion 54b and innermost planar portion 54c of annular side wall 54 of annual channel 50 and ramp portion 81b and innermost planar portion 81c of outboard inner ring face 81 of inner sealing ring 80. In addition, inner seal wall 144 of inner air seal 140 abuts outer channel wall 52 of annular channel 50 to form an air tight seal. When inner sealing ring 80 is properly positioned, inner seal wall 145 of inner air seal 140 forms a seal around outer wall 84 of inner sealing ring 80 using the bias created by inner seal spring 148 of inner air seal 140.

After placement of inner sealing ring 80, and now referring to FIGS. 10, 11, 20, & 21, annular bearing assembly 90 is then positioned into annual channel 50 of sealing body 30 so that outboard bearing ring face 91 of outer bearing ring 93 rests on lower bearing assembly seat 57 of channel inner wall 56 and outboard bearing ring face 91 of inner bearing ring 94 rests on inboard inner ring face 82 near inner wall 85 of inner sealing ring 80.

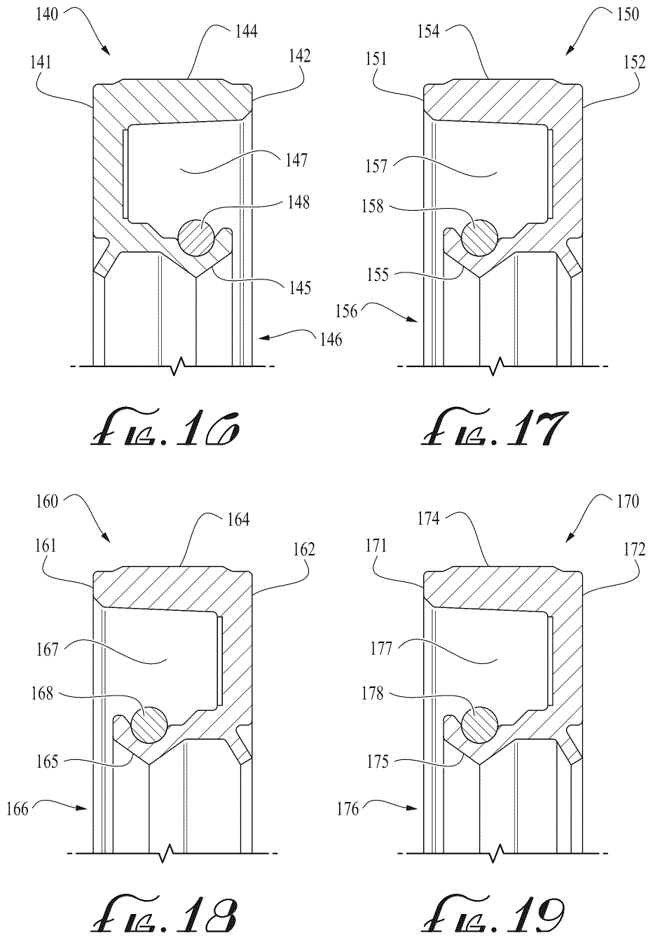

As best seen in FIGS. 4, 13A, 13B, & 21, outer sealing ring 100 is then fitted into annual channel 50 of sealing body 30 so that outboard ring face 101 of outer sealing ring 100 abuts inboard inner ring face 82 and first opening 88a of inner sealing ring air channel 88 located on inboard inner ring face 82 of inner sealing ring 80 is aligned with second opening 110b of outer sealing ring air channel 110 located on outbound outer ring face 101. Outboard outer ring face 101 is securely affixed to onboard inner ring face 82. In some embodiments, outboard outer ring face 101 and onboard inner ring face 82 are is securely affixed to each other by, e.g., a press-fit, fastening with bolts, pegs, rivets, or screws, brazing with a filler metal, soldering, welding, affixing with an adhesive, or other attachment means that securely join inboard inner ring face 82 and outboard outer ring face 101. As best seen in FIG. 21, alignment of inner sealing ring air channel 88 and outer sealing ring air channel 110 forms a contiguous sealing ring air channel 116 that enables gaseous communication therethrough.

In embodiments where tire inflation apparatus 20 comprises combined sealing ring 600, and as best seen in FIGS. 10, 11, 25, 37 & 38, after placement of inner air seal 140 annular bearing assembly 90 is then positioned into annual channel 50 of sealing body 30 so that outboard bearing ring face 91 of outer bearing ring 93 rests on lower bearing assembly seat 57 of channel inner wall 56.

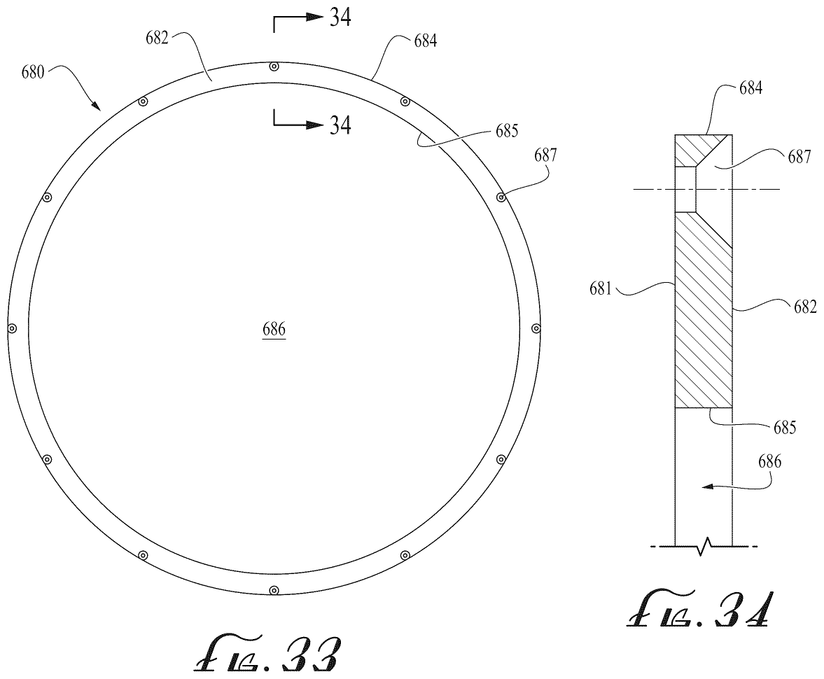

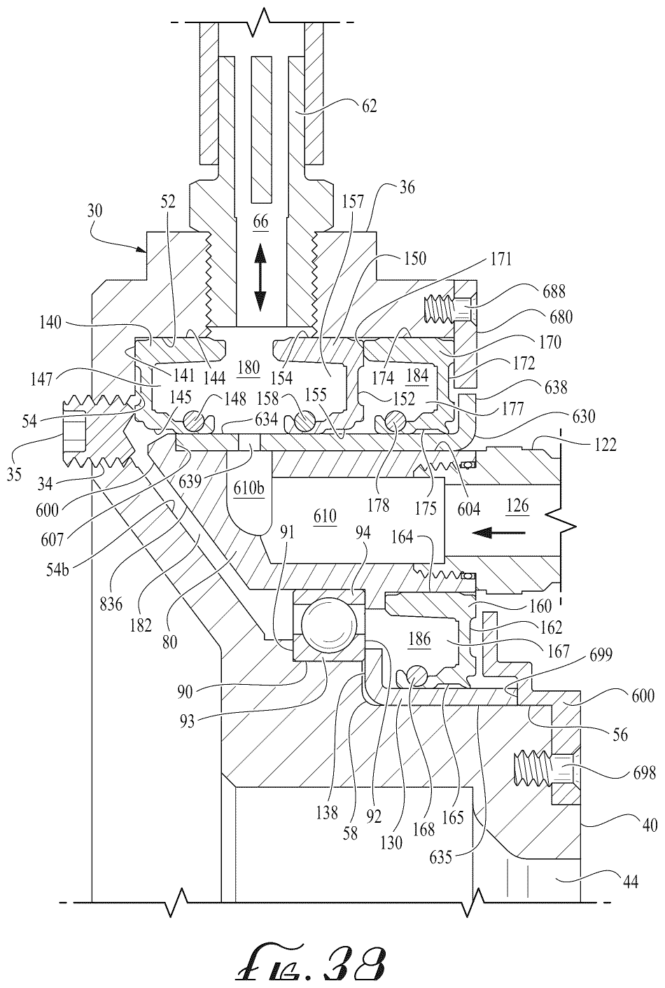

As shown in FIGS. 25, 31, 32, & 38, outer sealing sleeve 630 is slid over outer wall 604 of combined sealing ring 630 and positioned so that an edge of inboard sealing sleeve face 632 abuts outer sealing sleeve seat 607 of combined sealing ring 600. In addition, inner wall 635 of outer sealing sleeve 630 abuts outer wall 604 of combined sealing ring 600. Furthermore, as best seen in FIG. 37, plurality outer sealing sleeve channels 639 of outer sealing sleeve 630 is aligned with second opening 610b outer sealing sleeve 630. As the tolerance of inner wall 635 of outer sealing sleeve 630 and outer wall 604 of combined sealing ring 600 is a tight fit, movement of these two parts with respect to each other is prevented.

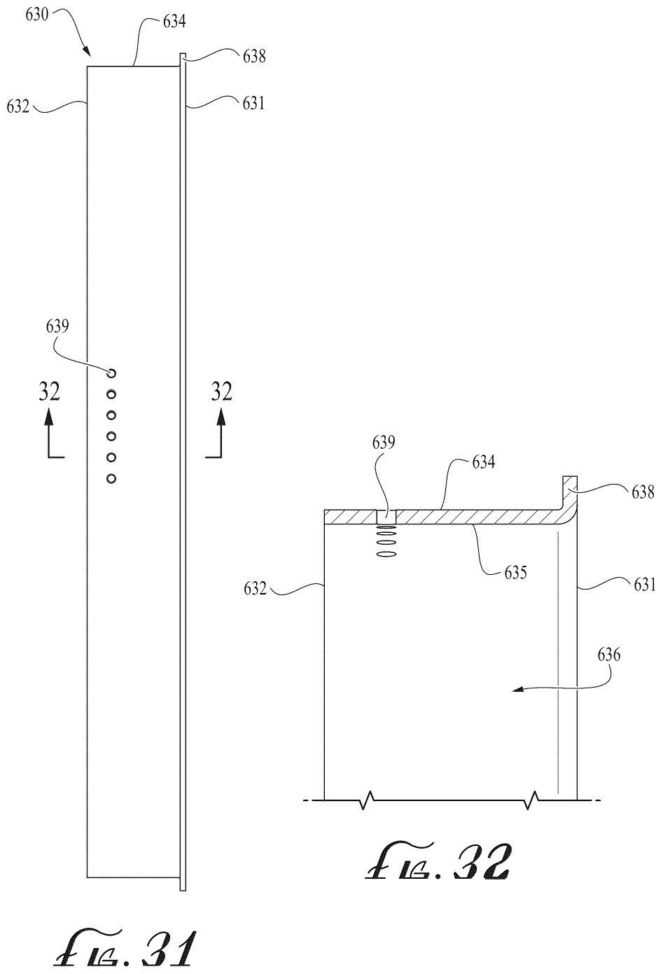

Once combined sealing ring 600 and outer sealing sleeve 630 are assembled, and after placement of annular bearing assembly 90, and now referring to FIGS. 28-30, 37, & 38, combined sealing ring 600 is then positioned into annual channel 50 of sealing body 30 so that upper bearing assembly seat 608 of combined sealing ring 600 rests on inboard bearing ring face 92 of outer bearing ring 93 of annular bearing assembly 90.

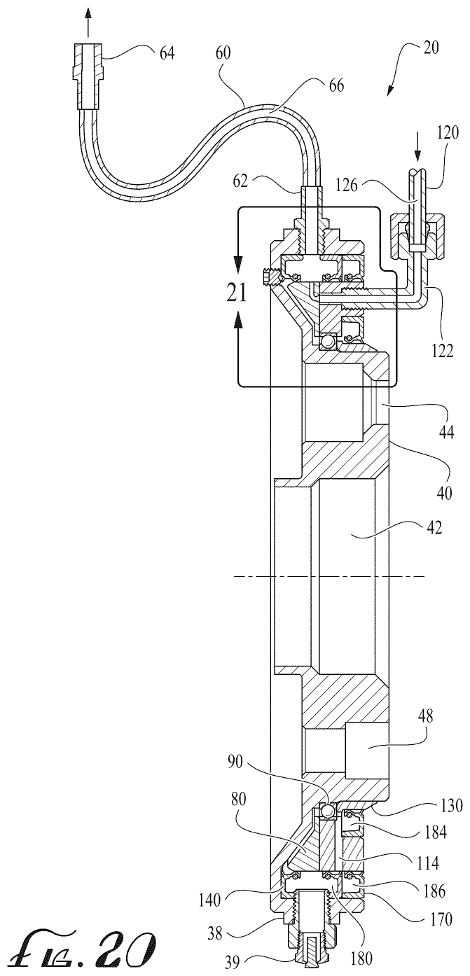

After placement of outer sealing ring 100 and outer sealing ring 100 assembly, or combined sealing ring 600 and outer sealing sleeve 630 assembly into annual channel 50 of sealing body 30, and referring to FIGS. 4, 15, & 21, inner sealing sleeve 130 is then positioned into annual channel 50 of sealing body 30. As shown in FIGS. 4, 15, & 21, inner sealing sleeve 130 is positioned so that inner sealing sleeve seat 138 of outboard sealing sleeve face 131 of inner sealing sleeve 130 abuts inboard bearing ring face 92 outer bearing ring 93 of annular bearing assembly 90 and sealing sleeve seat 58 of channel side wall 54. In addition, inner wall 135 of inner sealing sleeve 130 abuts channel inner wall 56 of annual channel 50. As the tolerance of inner wall 135 of inner sealing sleeve 130 and channel inner wall 56 of annual channel 50 is a tight fit, movement of these two parts with respect to each other is prevented. Furthermore, as best seen in FIGS. 21 & 38, placement of inner sealing sleeve 130, results in fluid communication between bearing fluid channels 98 of annular bearing assembly 90 and first annular fluid chamber 182.

In some embodiments, and as shown in FIG. 21, upon placement of inner sealing sleeve 130 into annual channel 50, annular bearing assembly 90 is trapped within an annular groove having two ridges. The first annular ridge abuts inner bearing ring 94 and is formed by inbound inner ring face 82 near inner wall 85 of inner sealing ring 80, inner wall 105 of outer sealing ring 100, and upper bearing assembly seat 108 of outer sealing ring 100. The second annular ridge abuts outer bearing ring 93 and is formed by lower bearing assembly seat 57 of channel inner wall 56, channel inner wall 56, and outbound sealing sleeve face 131 of inner sealing sleave seat 138 of inner sealing sleeve 130.

In some embodiments, and as shown in FIG. 38, upon placement of inner sealing sleeve 130 into annual channel 50, annular bearing assembly 90 is trapped between lower bearing assembly seat 57 of channel inner wall 56, upper bearing assembly seat 608 of combined sealing ring 600, and outbound sealing sleeve face 131 of inner sealing sleave seat 138 of inner sealing sleeve 130.

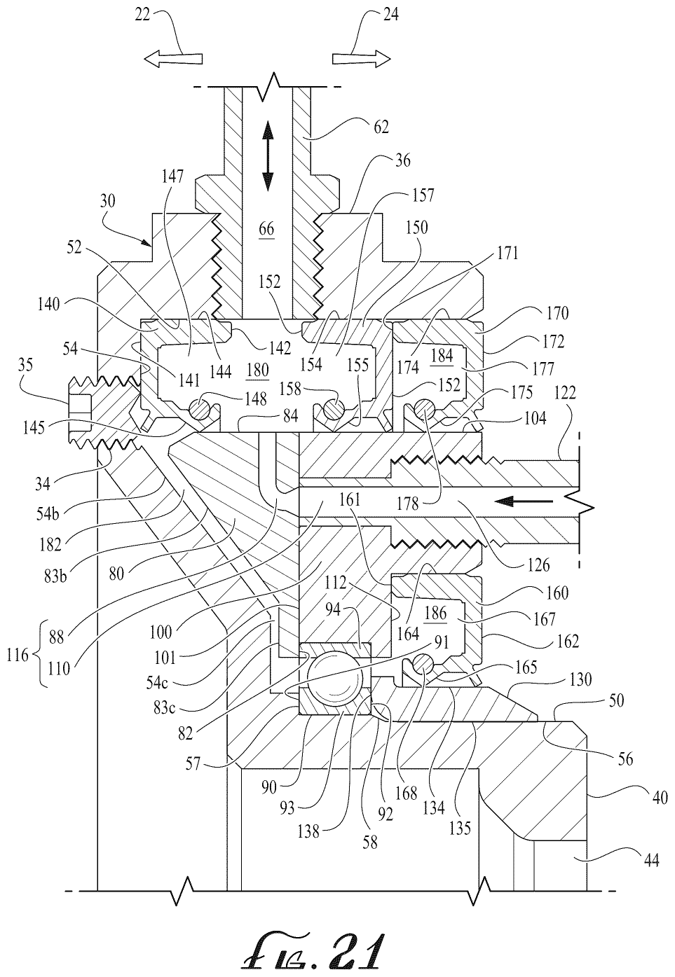

Referring to FIGS. 16, 20, 21, 37 & 38, inner air seal 140 is fitted into annual channel 50 of sealing body 30. In some embodiments, and as shown in FIGS. 16 & 21, inner air seal 140 is fitted into annual channel 50 so that outboard seal face 141 of inner air seal 140 abuts channel side wall 54 of annual channel 50, outer seal wall 144 of inner air seal 140 abuts channel outer wall 52 of annual channel 50, and inner seal wall 145 of inner air seal 140 abuts outer wall 84 of inner sealing ring 80. In some embodiments, and as shown in FIGS. 16 & 38, inner air seal 140 is fitted into annual channel 50 so that outboard seal face 141 of inner air seal 140 abuts channel side wall 54 of annual channel 50, outer seal wall 144 of inner air seal 140 abuts channel outer wall 52 of annual channel 50, and outer wall 634 of outer sealing sleeve 630.

Referring to FIGS. 17, 20, 21, 37 & 38, outer air seal 150 is fitted into annual channel 50 of sealing body 30. In some embodiments, and as shown in FIGS. 17 & 21, outer air seal 150 is fitted into annual channel 50 by positioning outboard seal face 151 of outer air seal 150 over inboard seal face 142 of inner air seal 140 and between channel side wall 54 of annular channel 50 and outer side wall 104 of outer sealing ring 100. As best seen in FIG. 21, these fitting forms annular air chamber 180, an air tight chamber defined by inner seal air channel 147 of inner air seal 140, outer seal air channel 157 of outer air seal 150, channel outer wall 52 of annular channel 50, and outer wall 84 of inner sealing ring 80. When properly positioned, inner seal wall 155 of outer air seal 150 forms a seal around outer wall 104 of outer sealing ring 100 using the bias created by outer seal spring 158 of outer air seal 150. Additionally, when inner air seal 140 and outer air seal 150 are properly positioned, annular air chamber 180 is formed by a gap between inboard seal face 142 of inner air seal 140 and outboard seal face 151 of outer air seal 150. As shown in FIG. 21, this gap enables gaseous communication between sealing ring air channel 116, annular air chamber 180, and air channel 66 of sealing body hose 60.

In some embodiments, and as shown in FIGS. 17 & 38, outer air seal 150 is fitted into annual channel 50 by positioning outboard seal face 151 of outer air seal 150 over inboard seal face 142 of inner air seal 140 and between channel side wall 54 of annular channel 50 and outer wall 634 of outer sealing sleeve 630. As best seen in FIG. 37, these fitting forms annular air chamber 180, an air tight chamber defined by inner seal air channel 147 of inner air seal 140, outer seal air channel 157 of outer air seal 150, channel outer wall 52 of annular channel 50, and outer wall 604 of combined sealing ring 600. When properly positioned, inner seal wall 155 of outer air seal 150 forms a seal around outer wall 104 of outer wall 634 of outer sealing sleeve 630 using the bias created by outer seal spring 158 of outer air seal 150. Additionally, when inner air seal 140 and outer air seal 150 are properly positioned, annular air chamber 180 is formed by a gap between inboard seal face 142 of inner air seal 140 and outboard seal face 151 of outer air seal 150. As shown in FIG. 38, this gap enables gaseous communication between combined sealing ring air channel 610, annular air chamber 180, and air channel 66 of sealing body hose 60.

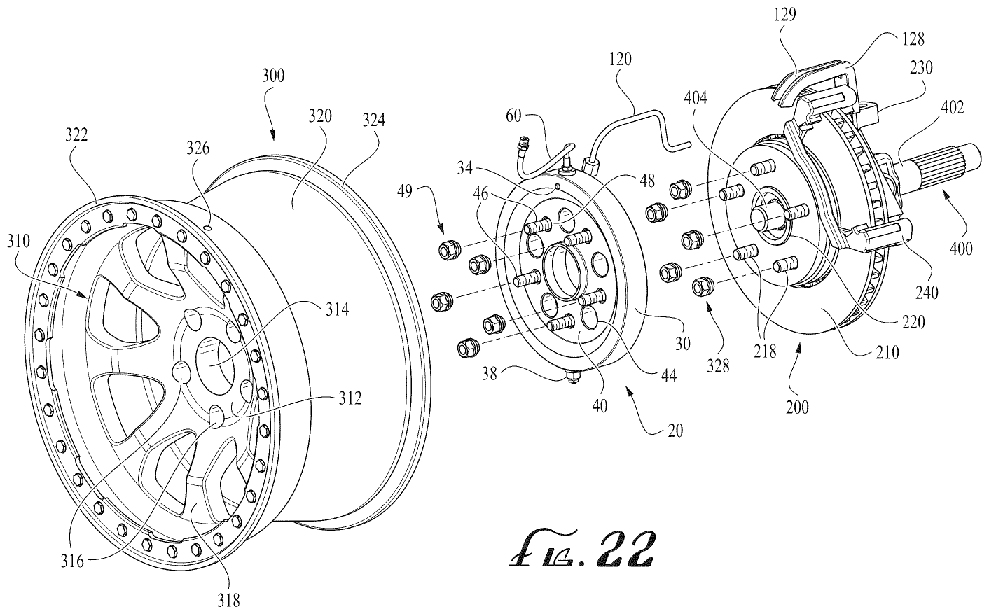

Referring to FIGS. 18, 20, 21, 37 & 38, lower fluid seal 160 is fitted into annual channel 50 of sealing body 30. In some embodiments, and as best seen in FIGS. 18 & 21, lower fluid seal 160 is fitted by inserting face seal face 161 of lower fluid seal 160 into an annular channel defined by lower fluid seal seat 112 of outer sealing ring 100 and outer wall 134 of inner sealing sleeve 130 to create a fluid tight seal and a smooth annular surface comprising inboard seal face 162 of lower fluid seal 160 and inboard outer ring face 102 of outer sealing ring 100. When properly positioned, inner seal wall 165 of lower fluid seal 160 forms a seal around outer wall 134 of inner sealing sleeve 130 using the bias created by lower seal spring 168 of lower fluid seal 160. As best seen in FIG. 21, placement of lower fluid seal 160 forms third annular fluid chamber 186 which is defined by lower fluid seal channel 167 of lower fluid seal 160, lower fluid seal seat 112 of outer sealing ring 100, and outer wall 134 of inner sealing sleeve 130. Third annular fluid chamber 186 is a fluid-tight annular channel that is in fluid communication with first annular fluid chamber 182 through a series of bearing fluid channels 98 of annular bearing assembly 90.

In some embodiments, and as best seen in FIGS. 18 & 38, lower fluid seal 160 is fitted into annual channel 50 of sealing body 30 by inserting face seal face 161 of lower fluid seal 160 into an annular channel defined by lower fluid seal seat 609 of combined sealing ring 600 and outer wall 634 of inner sealing sleeve 630 to create a fluid tight seal and a smooth annular surface comprising inboard seal face 162 of lower fluid seal 160 and inboard outer ring face 602 of combined sealing ring 600. When properly positioned, inner seal wall 165 of lower fluid seal 160 forms a seal around outer wall 134 of inner sealing sleeve 130 using the bias created by lower seal spring 168 of lower fluid seal 160. As best seen in FIG. 38, placement of lower fluid seal 160 forms third annular fluid chamber 186 which is defined by lower fluid seal channel 167 of lower fluid seal 160 and outer wall 134 of inner sealing sleeve 130. Third annular fluid chamber 186 is a fluid-tight annular channel that is in fluid communication with first annular fluid chamber 182 through a series of bearing fluid channels 98 of annular bearing assembly 90.

Referring to FIGS. 19-21, 37 & 38, upper fluid seal 170 is then fitted into annual channel 50 of sealing body 30. In some embodiments, and as best seen in FIGS. 19 & 21, upper fluid seal 170 is fitted by inserting outboard seal face 171 of upper fluid seal 170 on top of inboard seal face 152 of outer air seal 150 and between channel side wall 54 of annular channel 50 and outer side walls 104 of outer sealing ring 100 to create a fluid tight seal and a smooth annular surface comprising inboard seal face 172 of upper fluid seal 170 and inboard outer ring face 102 of outer sealing ring 100. When properly positioned, inner seal wall 175 of upper fluid seal 170 forms a seal around outer wall 104 of outer sealing ring 100 using the bias created by upper seal spring 178 of upper fluid seal 170. As best seen in FIG. 21, this fitting forms second annular fluid chamber 184 which is defined by inboard seal face 152 of outer air seal 150 and upper seal fluid channel 177 of outboard seal face 171 of upper fluid seal 170. Second annular fluid chamber 184 is a fluid-tight annular channel that is in fluid communication with third annular fluid chamber 186 through a series of fluid channels 114 of outer sealing ring 100.

In some embodiments, and as best seen in FIGS. 19 & 38, upper fluid seal 170 is then fitted into annual channel 50 of sealing body 30 by inserting outboard seal face 171 of upper fluid seal 170 on top of inboard seal face 152 of outer air seal 150 and between channel side wall 54 of annular channel 50 and outer side walls 604 of combined sealing ring 600 to create a fluid tight seal and a smooth annular surface comprising inboard seal face 172 of upper fluid seal 170 and inboard outer ring face 602 of combined sealing ring 600. When properly positioned, inner seal wall 175 of upper fluid seal 170 forms a seal around outer wall 604 of combined sealing ring 600 using the bias created by upper seal spring 178 of upper fluid seal 170. As best seen in FIG. 38, these fitting forms second annular fluid chamber 184 which is defined by inboard seal face 152 of outer air seal 150 and upper seal fluid channel 177 of outboard seal face 171 of upper fluid seal 170. Second annular fluid chamber 184 is a fluid-tight annular channel that is in fluid communication with third annular fluid chamber 186 through a series of fluid channels 614 of combined sealing ring 600.

Referring to FIGS. 33, 34, 37 & 38, outer retainer ring 680 is fitted into annual channel 50 of sealing body 30 by positioning outer retainer ring 690 so that outboard retainer ring face 681 rests upon outer side wall 33 of sealing body 30 with outer diameter of outer retainer ring 680 flush with outer side wall 33 of sealing body 30 and each sealing body through hole 687 is aligned with its corresponding outer retainer ring attachment point 37. Screw 688 is then inserted through each sealing body through hole 687 and threadably secured to outer retainer ring attachment point 37, thereby securing outer retainer ring 680 to outer side wall 33 of sealing body 30. Placement of outer retainer ring 680 in conjunction with sealing sleeve seat 638 of outer sealing sleeve 630 enclose annular channel 50 of sealing body 30 and secures in place inner air seal 140, outer air seal 150, and upper fluid seal 170.

Referring to FIGS. 35-38, inner retainer ring 690 is then fitted into annual channel 50 of sealing body 30 by positioning inner retainer ring 690 so that inner sealing seat 699 rests upon an edge of inboard inner sealing sleeve face 132 of inner sealing sleeve 130 and each sealing hub through hole 697 is aligned with its corresponding inner retainer ring attachment point 43. Screw 698 is then inserted through each sealing hub through hole 697 and threadably secured to inner retainer ring attachment point 43, thereby securing inner retainer ring 690 to sealing hub 40 of sealing body 30. Placement of inner retainer ring 690 encloses annular channel defined by lower fluid seal seat 609 of combined sealing ring 600 and outer wall 634 of inner sealing sleeve 630 and secures in place lower fluid seal 160.

Assembled as described above, tire inflation apparatus 20 comprises a rotating outer hub 72 and a stationary inner hub 74. Components of rotating outer hub 72 will behave as a single unit that will rotate in unison with hub assembly 200 and wheel 300. In some embodiments, rotating outer hub 72 comprises assembled sealing body 30, annular bearing assembly 90, inner sealing sleeve 130, inner air seal 140, outer air seal 150, and upper fluid seal 170 will behave as a single unit that will rotate in unison with hub assembly 200 and wheel 300 and can be referred to as a rotating outer hub 72 of tire inflation apparatus 20. In some embodiments, rotating outer hub 72 comprises assembled sealing body 30, annular bearing assembly 90, inner sealing sleeve 130, inner air seal 140, outer air seal 150, upper fluid seal 170, and outer retainer ring 680. Components of stationary inner hub 74 will behave as a single unit as these components remain in a stationary position in relation to the rotational movement of hub assembly 200 and wheel 300. In some embodiments, stationary inner hub 74 comprises assembled inner sealing ring 80, outer sealing ring 100, and lower fluid seal 160. In some embodiments, stationary inner hub 74 comprises assembled combined sealing ring 600, outer sealing sleeve 630, and lower fluid seal 160.

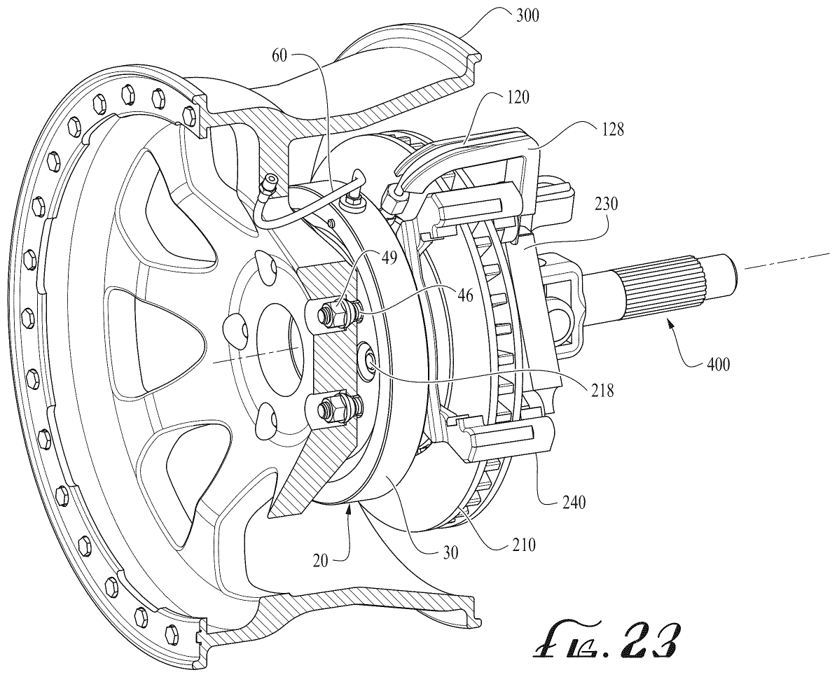

In addition, assembled as described above, a contiguous, hermetically sealed air channel system is formed in tire inflation apparatus 20 that provides air or other inflation gas from an air supply assembly. As best seen in FIGS. 20, 21, 37 & 38, this contiguous air channel system enables gaseous communication therethrough of a pressurized gas and comprises air channel 66 of sealing body hose 60 from a tire valve stem of a tire to body hose attachment port 36 of sealing body 30 which then continues on to annular air chamber 180 formed by inner air seal 140 and outer air seal 150 which then continues on to sealing ring air channel 116 formed by inner sealing ring air channel 88 of inner sealing ring 80 and outer sealing ring air channel 110 of outer sealing ring 100 or combined sealing ring air channel 610 of combined sealing ring 600, which then continues on to air channel 126 of sealing ring hose 120 from first opening of outer sealing ring air channel 110 of outer sealing ring 100 to a gas air port of an air supply assembly. Since annular air chamber 180 is a contiguous chamber that encircles sealing body 30, both air channel 66 of sealing body hose 60 and sealing ring air channel 116 or combined sealing ring air channel 610 of combined sealing ring 600 are in continuous gaseous communication with each other.

Furthermore, assembled as described above, tire inflation apparatus 20 forms a hermetically sealed and self-contained fluid channel system is formed. As best seen in FIGS. 21 38, this contiguous fluid channel system enables fluid communication therethrough of a fluid such as an oil and comprises first annular fluid chamber 182, bearing fluid channels 98 of annular bearing assembly 90, third annular fluid chamber 186, fluid channels 114 of outer sealing ring 100 or fluid channels 614 of combined sealing ring 600, and second annular fluid chamber 184. Fluid port 34 located on outer side wall 33 of sealing body 30 permits filling and drainage of the oil or other lubricating fluid into fluid channel system of tire inflation apparatus 20 with a set screw acting as fluid port plug 35. Oil within fluid channel system of tire inflation apparatus 20 provides lubrication to permit rotation of assembled inner sealing ring 80 and outer sealing ring 100 or combined sealing ring 600 relative to sealing body 30 and prevents air from leaking through inner air seal 150 and outer air seal 160 of annular air chamber 180. First annular fluid chamber 182, second annular fluid chamber 184, and third annular fluid chamber 186 seal the air channel system of tire inflation apparatus 20 to prevent leakage and contamination.

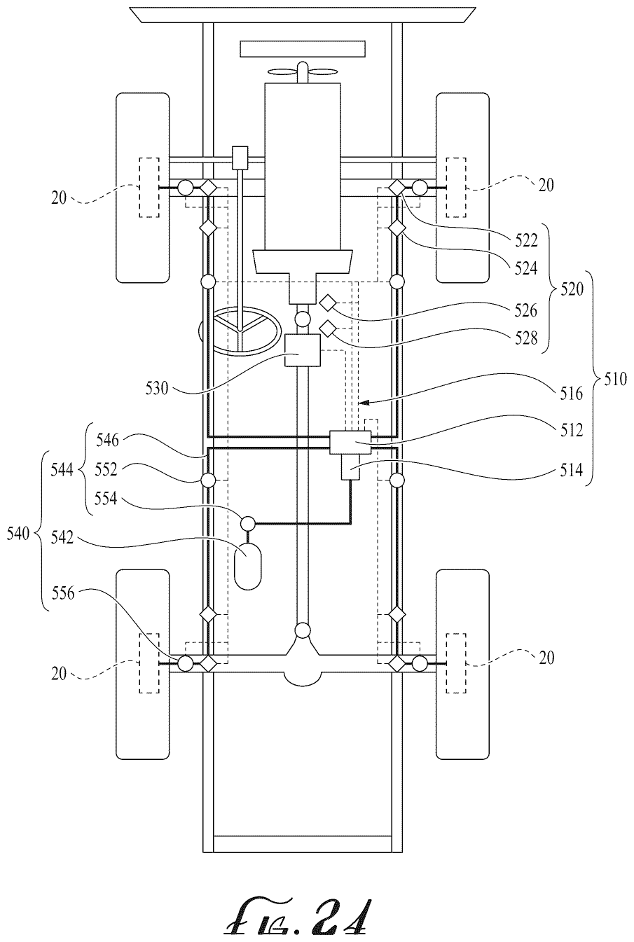

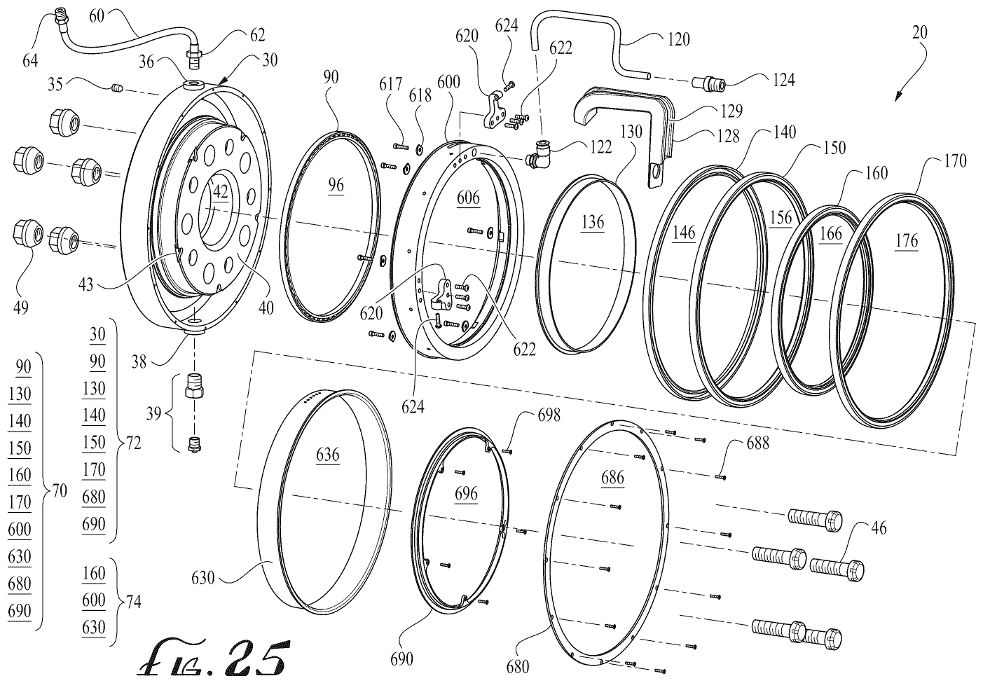

Tire inflation apparatus 20 is attachable between a hub assembly and a wheel and of a vehicle. As shown in FIGS. 22 & 23, a hub assembly 200 typically comprises a rotor 210 having a brake disc 212 around the periphery and a centrally located wheel hub 214. Wheel hub 214 further includes a centrally located hub bore 216 and one or more wheel studs 218 perpendicularly protruding from and equally space around the periphery of wheel hub 214, with hub bore 216 configured to receive a bearing assembly 220. Hub assembly 200 further comprises a suspension knuckle 230 with attachment points 232 and a brake caliper assembly 240 (FIGS. 22 & 23 only depicts a caliper bracket and does not illustrate other brake components, e.g., the calipers or beak pads). Suspension knuckle 230 is used to secure hub assembly 200 to a suspension system of a vehicle.

FIGS. 22 & 23 also depicts wheel 300 which typically comprises a wheel dish 310, a barrel 320, and one or more wheel stud nuts 328. Wheel dish 310 includes a center cap 312 and one or more spokes 318. Center cap 312 comprises a centrally located wheel bore 314 and one or more wheel stud holes 316 equally space around the periphery of center cap 312 and configures to align with one or more wheel studs 218 of hub assembly 200. Barrel 320 comprises an outer rim 322 which defines an outer edge of barrel 320, an inner rim 324 which defines an inner edge of barrel 320, and a valve stem hole 326. Each of the one or more wheel stud nuts 328 is configured to securely attached to one of the one or more wheel studs 218. A tire is fitted over barrel 320 so that the tire valve stem of tire is inserted through valve stem hole 326 of wheel 300 and outer rim 322 and inner rim 324 form an air tight seal with outer and inner beads of outer and inner side walls of tire respectively.

Also shown in FIG. 22 is a portion of an axle assembly 400. Axle assembly 400 includes a drive shaft 402 and stub axle 404. Hub bore 216 of hub assembly 200 is configured to receive stub axle 404.

As illustrated in FIGS. 22 & 23, tire inflation apparatus 20 is shown aligned and ready for installation between a hub assembly 200 and a wheel 300. During installation, tire inflation apparatus 20 is positioned onto hub assembly 200 in a manner where stub axle 404 of axile assembly 400 is inserted through sealing hub bore 34 of sealing body 30, annular lip of bearing assembly 220 of hub assembly 200 rests within sealing hub bore 34, each of the one or more wheel studs 218 of hub assembly 200 is inserted through one of the one or more wheel stud holes 48 of sealing body 30, and brake caliper bracket 240 is aligned between one or more caliper brackets 620. Each of the one or more wheel stud nuts 328 is then secured to one of the one or more wheel studs 218 to affix tire inflation apparatus 20 to hub assembly 200. In addition, caliper bracket screw 624 for each of brake caliper bracket 240 is tightened to securely attach one or more caliper brackets 620 and brake caliper bracket 240 and ensure that tire inflation apparatus 20 remains stationary relative to brake caliper bracket 240. Additionally, first ring hose fitting 122 of sealing ring hose 120 is reversibly connected to first opening 110a of outer sealing ring air channel 110 of outer sealing ring 100 while second ring hose fitting 124 is reversibly connected to a fitting present on a tire hose assembly or directly to a wheel valve of a centralized tire inflation system in a manner that nests sealing ring hose 120 within a channel of hose bracket 128. In this configuration, hose bracket 128 guides sealing ring hose 120 around moving parts of hub assembly 200 (such as, e.g., rotor 210) and wheel 300 and sealing ring assembly 70 remains substantially rotationally stationary relative to sealing body 30 and wheel 300, as the wheel 300 rotates. Further rigidity to resist rotation may be provided if sealing ring hose 120 is made of metal pipe rather than a flexible hose, although both are acceptable in one or more embodiments.

Wheel 300 is then positioned onto tire inflation apparatus 20 in a manner where each of the one or more sealing hub studs 46 of sealing body 30 is inserted through one of the one or more wheel stud holes 316 of center cap 312. One of the one or more sealing hub nuts 49 is then secured to each of the one or more sealing hub studs 46 to affix wheel 300 to tire inflation apparatus 20 and hub assembly 200. Ring hose bracket 128 is fastened to a non-rotating part of the vehicle, such as, e.g., to attachment point 232 of suspension knuckle 230 of hub assembly 200. Additionally, first body hose fitting 62 of sealing body hose 60 is reversibly connected to body hose attachment port 36 of sealing body 30 while second body hose fitting 64 is then reversibly connected to a tire valve of a tire, typically by inserting sealing body hose 60 through an opening between two spokes 318 of a wheel 300.

Once tire inflation apparatus 20 is securely bolted between hub assembly 200 and wheel 300, sealing body 30 is firmly attached with wheel 200 and hub assembly 300. Rotating outer hub 72 of tire inflation apparatus 20 and sealing body hose 60 will rotate in unison with hub assembly 200 and wheel 300. Stationary inner hub 74 of tire inflation apparatus 20 and sealing ring hose 120 are rigidly held in a stationary position by ring hose bracket 128, bolted to suspension knuckle 230. Assembled sealing ring hose 120, in conjunction with annular bearing ring assembly 90, will prevent stationary inner hub 74 from substantially rotating relative to rotating outer hub 72.

In this arrangement, body hose air channel 66 will rotate around annular air chamber 180 as the sealing body 30 rotates during operational movement of a vehicle while sealing ring air channel 116 or combined sealing ring air channel 610 and downstream ring hose air channel 126 remains substantially stationary. Thus, even though body hose air channel 66 and sealing ring air channel 116 or combined sealing ring air channel 610 will only briefly align during movement, when inflation of a tire is desired, air or other inflation gas can be continuously provided from an air supply assembly to a tire because body hose air channel 66 is always in gaseous communication through annular air chamber 180 and the higher pressure from the air supply assembly will force air or other inflation gas into the tire. Conversely, when deflation of a tire is desired, air can be released from a tire into annular air chamber 180 using body hose air channel 66 by utilizing the higher air pressure within the tire relative to the ambient pressure of annular air chamber 180.

The present application also discloses a centralized tire inflation system (CTIS). A CTIS disclosed herein maximizes vehicle mobility and performance in demanding terrain and conditions by adjusting the tire pressure to improve traction, eliminate tire leak, and reduce soil compaction. This gives the operator complete control over a vehicle from inside the cabin. A CTIS disclosed herein has three general functions: 1) detect when the air pressure in a particular tire has dropped by constantly or intermittently monitoring of the air pressure in each tire; 2) notify the driver of the problem; and 3) inflate that tire back to the proper level by use of a tire inflation apparatus disclosed herein.

In some embodiments, and referring now to FIG. 24, a CTIS 500 comprises one or more tire inflation apparatus 20, a control system 510, an operator control panel 530, and an air supply assembly 540. Generally, tire inflation apparatus 20 is installed between each hub assembly 200 and a wheel 300 present on a vehicle. For example, a two-wheeled vehicle will have tire inflation apparatus 20 installed between each of the two hub assemblies 200 and wheels 300 present on the two-wheeled vehicle, a three-wheeled vehicle will have tire inflation apparatus 20 installed between each of the three hub assemblies 200 and wheels 300 present on the three-wheeled vehicle, and a four-wheeled vehicle will have tire inflation apparatus 20 installed between each of the four hub assemblies 200 and wheels 300 present on the four-wheeled vehicle. Although best performance is generally achieved by installing tire inflation apparatus 20 on each of the hub assemblies 200 and wheels 300 present on a wheeled vehicle, it is not a requirement that all hub assemblies 200 and wheels 300 be installed with tire inflation apparatus 20 as there are situations where only a subset of tire inflation apparatus 20 need to be or are desired to be installed.

Control system 510 comprises one or more hardware processors, one or more memory chips, one or more circuit boards, and/or computing devices or circuits. Control system 510 is programmed or configured to implement instructions which dynamically control, adjust, and/or monitor one or more parameters of CTIS 500. Control system 510 can implement instructions based information, instructions, or other input received by an operator using operator control panel 530. In addition, or alternatively, control system 510 can implement instructions autonomously or semi-autonomously based information, instructions, or other input received by one or more sensors of control system 510, or by using an artificial intelligence (AI) or machine-learning system connected to control system 510. Once this input is received, control system 510 can process this input and implement pre-programed and/or real-time executable instructions and/or parameters from memory or a computer-readable medium. In some embodiments, instructions implemented by control system 510 can 1) independently inflate each tire present in a vehicle to a specified air pressure; 2) independently deflate each tire present in a vehicle to a specified air pressure; 3) independently set a desired air pressure for each tire present in a vehicle and enable automatic inflation or deflation to that desired air pressure; 4) monitor air pressure range for each tire present in a vehicle; 5) detect and provide a warning when an error or malfunction occurs in CTIS 500; and 6) tract usage of CTIS 500 and provide maintenance notifications to an operator.

Referring to FIG. 24, control system 510 comprises, an electronic control unit 512, a pneumatic control unit 514, and one or more sensors 520. An electronic control unit 512 is a field programmable, microprocessor-based control center for CTIS 500 that comprises one or more hardware processors, one or more memory chips, one or more circuit boards, and/or computing devices or circuits. Electronic control unit 512 is in electronic communication via a wire harness 516 and is directly or indirectly responsive to signals received from pneumatic control unit 514, one or more sensors, operator control panel 530, and air supply assembly 540. Electronic control unit 512 processes, monitors, and coordinates operator selections and commands and all system signals throughout CTIS 500, electronically communicates with a vehicle CAN Bus, monitoring power, speed, and other operational or performance parameters of the vehicle to optimize vehicle performance, as well as provides decision making and logic execution. Electronic control unit 512 also performs checks to make sure CTIS 500 is operational, notifies an operator via an operator control panel, and performs system diagnostics.

In some embodiments, electronic control unit 512 can 1) check current pressure to ensure selected pressure is being maintained; 2) adjust tire pressure by either inflating or deflating a tire; 3) adjust engine speed, transmission shifting, ABS, and axle differential locks; 4) optimize tire pressures based on axle loads; 5) check pressure reserves of a braking or pneumonic system; 6) initiate self-diagnostics of CTIS 500; 7) send information to operator control panel 530; and 8) respond to input signals received from operator control panel 530.

Referring to FIG. 24, pneumatic control unit 514 is used to monitor, distribute, and control compressed or pressurized air or other inflation gas of air supply assembly 540. Pneumatic control unit 514 comprises a manifold and one or more electropneumatic valves. A manifold is used to control and direct airflow of compressed or pressurized air or other inflation gas to one or more tires based on instructions received from electronic control unit 512. An electropneumatic valve is used to isolate individual tires and prevent airflow from all tires when one tire is being checked, inflated, or deflated. Pneumatic control unit 514 is in electronic communication via wire harness 516 and is directly or indirectly responsive to signals received from electronic control unit 512, one or more sensors, operator control panel 530, and air supply assembly 540.

In some embodiments, pneumatic control unit 514 can 1) directly controls a wheel valve 556 of air supply assembly 540 and inflate, deflate, or measure tire pressures by wheel position or axle groups; 2) control pressurization of air supply assembly 540 and maintains pressurization only during inflate/deflate cycles, extending air seal life; 3) send information to operator control panel 530; and 4) respond to input signals received from operator control panel 530.

Control system 510 comprises one or more sensors to collect operational parameters or other information of CTIS 500. Sensor 520 is in electronic communication via wire harness 516 and are directly or indirectly responsive to signals received from electronic control unit 512, pneumatic control unit 514, operator control panel 530, and air supply assembly 540. Non-limiting examples of operational parameters or other information collected by one or more sensors 520 include operational parameters or other information of tire inflation apparatus 20, operational parameters or other information electronic control unit 512, operational parameters or other information of pneumatic control unit 514, operational parameters or other information of a tire or other component of a vehicle, operational parameters or other information of operator control panel 530, operational parameters or other information of a tire or other component of a vehicle, operational parameters or other information of operator control panel 530, operational parameters or other information of air supply assembly 540.

As shown in FIG. 24, one or more sensors 520 can comprise a pressure sensor 522, an air flow sensor 524, a speed sensor 526, and a load sensor 528. Pressure sensor 522 monitors and collects information on the air pressure in each tire and then transmits this information to electronic control unit 512. This enables CTIS 500 to monitor tire pressure and automatically inflate or deflate a tire to an appropriate pressure and/or send a notification to an operator via operator control panel 530 an adjustment to tire pressure is required.

Air flow sensor 524 monitors and collects information on air usage and delivery to a tire and then transmits this information to electronic control unit 512. This enables CTIS 500 to detect when significant amounts of air are delivered to a tire and send a notification to an operator via operator control panel 530 indicating a potential puncture in a tire.

Speed sensor 526 is an optional sensor to CTIS 500. Speed sensor 526 monitors and collects information on vehicle speed and then transmits this information to electronic control unit 512. This enables CTIS 500 to assess vehicle speed over a set period of time and automatically inflate or deflate the tires to an appropriate pressure for that speed.

Load sensor 528 is an optional sensor to CTIS 500. Load sensor 528 monitors and collects information on vehicle load and then transmits this information to electronic control unit 512. This enables CTIS 500 to assess vehicle load over a set period of time and automatically inflate or deflate the tires to an appropriate pressure for that load.

Control system 510 can be powered by a dedicated power source present in a vehicle or can be recharged using a rechargeable power source external to the vehicle. Power is supplied via a power induction component that is configured to transfer electrical power from a power source to the printed circuit boards.

Referring to FIG. 24, operator control panel 530 is an easy-to-use interface to manage overall functionality and features of CTIS 500 and enables an operator to enter information, instructions, or other input useful for the operation of CTIS 50. For example, operator control panel 530 can display current system status, such as, e.g., the air pressure for each tire, the selected operational mode, as well as other visual indications or diagnostics regarding the current system settings and system performance. In addition, operator control panel 530 is used by an operator to set-up, adjust, and control CTIS 500, such as, e.g., by enabling the operator to select tire-pressure settings to match current conditions, select different terrain settings, and select different load settings, and/or to automatic control settings that control CTIS 500 without operator input. When an operator selects a parameter, feature, or mode setting, input signals from operator control panel 530 are transmitted to control system 510.

Typically, a dash-mounted panel, an operator control panel 530 is within the cabin in an easily accessible location for the operator and allows an operator to remotely control CTIS 500. In some embodiments, operator control panel 530 can be a touchscreen comprising a touch panel and visual display and uses touch input from an operator to remotely operate CTIS 500 from within the cabin of the vehicle. In some embodiments, operator control panel 530 can be a panel comprising buttons, switches, toggles, knobs, or any combination thereof where an operator inputs information by physically changing a positional setting. A panel can communicate information to an operator by a visual display or through lights or positional location that indicate whether a feature or parameter is selected. An operator control panel can comprise a pressure adjustment feature that allows for adjustments to the overall air pressure maintained in CTIS 500.

As shown in FIG. 24, air supply assembly 540 comprises an air source 542, a tire hose assembly 544, and one or more wheel valves 556. In some embodiments, air supply assembly 540 further comprises an inlet filter to remove moisture and contaminants from compressed or pressurized air before delivery to a tire, one or more solenoids to control airflow to the tires, or any combination thereof.

Air source 542 provides compressed or pressurized air or other inflation gas used to inflate one or more tires of a vehicle and can be an existing onboard air source or an add-on air source. Non-limiting examples of an existing onboard air source, include, a braking system of a vehicle or a pneumatic system of a vehicle, or other onboard system that generates or contains compressed or pressurized air or another appropriate inflation gas. Non-limiting examples of an add-on air source, include, an air compressor, a container of compressed or pressurized gas like a compressed or pressurized nitrogen, or other add-on air source designed to generate or contain compressed or pressurized air or other appropriate inflation gas. In some embodiments, air source 542 is an air compressor that generates air, such as, e.g., a compressor that supplies air to a braking system of a vehicle, a compressor that supplies air to a pneumatic system of a vehicle, or an add-on air compressor.

In some embodiments, air source 542 is a container filled with compressed or pressurized air or other inflation gas, such as, e.g., a container filled with compressed or pressurized air that supplies air to a braking system of a vehicle, a container filled with compressed or pressurized air that supplies air to a pneumatic system of a vehicle, or an add-on container filled with compressed or pressurized air or another inflation gas, such as, e.g., compressed or pressurized nitrogen.

In some embodiments, tire hose assembly 544 comprises one or more air hoses 546, a pressure protection valve 552, and one or more quick release valves 554. Air hoses 546 provides an air route from the air source to the tire inflation apparatus 20 present on a tire and is used to deliver compressed or pressurized air or other inflation gas to inflate a tire of a vehicle.

Pressure protection valve 552 is an optional component that is necessary when an existing onboard air source is used to generate compressed or pressurized air or another appropriate inflation gas, include, a braking system of a vehicle or a pneumatic system of a vehicle, or other onboard system. Pressure protection valve 552 acts as an electronic brake priority switch and provides priority air delivery to a braking or pneumatic system by suspending CTIS 500 operation in the event of low air pressure in air source 542. Pressure protection valve 552 dynamically monitors pressure of air source 542 and prevents CTIS 500 from taking air from air source 542 of a braking or pneumatic system until the braking or pneumatic system is adequately charged with compressed or pressurized air, such as, e.g., air source 542 having 80 psi or higher of air. As such, pressure protection valve 552 ensures that compressed or pressurized air delivery to a braking or pneumatic system of a vehicle is prioritized over compressed or pressurized air delivery to CTIS 500. In addition, pressure protection valve 552 also ensures that enough pressure exists for CTIS 500 to operate properly.

Quick release valve 554 is an optional component and is used to depressurizes one or more air hoses 546 after an initial pressure check or inflation of a tire by CTIS 500. Quick release valves 554 ensures that one or more air hoses 546 as well as any seals associated with CTIS 500 are not continuously maintained under pressure when CTIS 500 is not checking or inflating a tire, which cuts down on wear and tear on one or more air hoses 546 as well as any seals associated with CTIS 500.

Referring to FIG. 24, air supply assembly 540 comprises one or more wheel valves 556. Wheel valve 556 controls inflation and deflation of a tire by isolating each tire to ensure that while the air pressure in one tire is being adjusted, the other tires don't lose pressure and deflate.

Aspects of the present specification can also be described by the following embodiments:
1. A tire inflation system comprising: a rotating outer hub comprising a first air channel; a stationary inner hub comprising a second air channel; and an annular air channel, the annular air chamber provides gaseous communication between the first air channel and the second air channel; wherein the first air channel provides gaseous communication between a stem valve of a tire and the annular air chamber; wherein the second air channel provides gaseous communication between an air source to the annular air chamber; and wherein the tire inflation system is configured to reversibly attach to a hub assembly of a vehicle and configured to receive for reversable attachment a wheel of the vehicle.
2. The tire inflation system of embodiment 1, wherein the rotating outer hub further comprises a first annular fluid channel and a second annular fluid channel, the first annular fluid channel and second annular fluid channel surrounding the annular air chamber to form a seal around the annular air chamber.
3. The tire inflation system of embodiment 2, wherein the stationary inner hub further comprises a third annular fluid channel, wherein the third annular fluid channel is in fluid communication with the first annular fluid channel and second annular fluid channel.
4. The tire inflation system of any one of embodiments 1-3, wherein the rotating outer hub comprises an inner air seal, and an outer air seal, wherein the inner air seal and the outer air seal form the annular air chamber.
5. The tire inflation system of any one of embodiments 1-4, wherein the rotating outer hub comprises a sealing body and an inner sealing ring, wherein the sealing body and the inner sealing ring form a first annular fluid channel.
6. The tire inflation system of any one of embodiments 1-5, wherein the rotating outer hub comprises an upper fluid seal, wherein the upper fluid seal form a second annular fluid channel.
7. The tire inflation system of any one of embodiments 1-6, wherein the stationary inner hub comprises an inner sealing ring, an outer sealing ring, and a lower fluid seal, the lower fluid seal forming a third annular fluid channel.
8. The tire inflation system of any one of embodiments 1-6, wherein the stationary inner hub comprises a combined sealing ring and a lower fluid seal, the lower fluid seal forming a third annular fluid channel.
9. A centralized tire inflation system comprising: a tire inflation system of any one of embodiments 1-8, a control system, an operator control panel, and an air supply assembly.
10. A tire inflation apparatus comprising: a ring housing, the ring housing comprising a sealing body; a ring assembly, the ring assembly having a ring assembly air channel; and a sealing assembly, the sealing assembly comprising an inner air seal and an outer air seal configured to form an annular air chamber; wherein the ring housing is configured to reversibly attach to a hub assembly of a vehicle and configured to receive for reversable attachment a wheel of the vehicle; a ring housing hose, the ring housing hose having a first fitting configured to reversibly and securely attached to a tire stem value of a tire and a second fitting configured to reversibly and securely attach to a housing attachment port on the ring housing; a ring assembly hose, the ring assembly hose having a first fitting configured to reversibly and securely attached to an attachment port on the ring assembly and a second fitting configured to reversibly and securely attach to a port of an air source; wherein the ring housing hose and ring housing comprise a first air channel providing gaseous communication between the tire stem valve and the annular air chamber, wherein the ring assembly hose and the ring assembly comprise a second air channel providing gaseous communication between the air source to the annular air chamber, and wherein the annular air chamber provides gaseous communication between the first air channel and the second air channel.
11. The tire inflation system of embodiment 10, wherein the sealing body rotates in unison with the hub assembly and the wheel of the vehicle.
12. The tire inflation system of embodiment 10 or 11, wherein the ring assembly remains in a stationary position in relation to the rotational movement of the hub assembly and the wheel of the vehicle.
13. The tire inflation system of any one of embodiments 10-12, wherein the sealing body further comprises a first annular fluid channel and a second annular fluid channel, the first annular fluid channel and second annular fluid channel surrounding the annular air chamber to form a seal around the annular air chamber.
14. The tire inflation system of embodiment 13, wherein the ring assembly further comprises a third annular fluid channel, wherein the third annular fluid channel is in fluid communication with the first annular fluid channel and second annular fluid channel.
15. The tire inflation system of any one of embodiments 10-14, wherein the ring assembly comprises an inner sealing ring, wherein the sealing body and the inner sealing ring form a first annular fluid channel.
16. The tire inflation system of any one of embodiments 10-15, wherein the sealing body comprises an upper fluid seal, wherein the upper fluid seal form a second annular fluid channel.
17. The tire inflation system of any one of embodiments 10-16, wherein the ring assembly comprises a lower fluid seal, the lower fluid seal forming a third annular fluid channel.
18. A centralized tire inflation system comprising: a tire inflation system of any one of embodiments 10-17, a control system, an operator control panel, and an air supply assembly.
19. A tire inflation system comprising: a sealing body having a hub and an annular air channel formed concentrically around the hub, a first air passage arranged within the annular channel and formed through the sealing body; a sealing ring arranged concentric with and at least partially within the annular air channel and surrounding the hub, the inner ring being rotatably coupled with the sealing body through a bearing, a second fluid passage formed through the sealing ring; a first annular fluid chamber being at least partially delineated by a first annular seal, the annular channel, the sealing ring, and a second annular seal, the first annular seal arranged between the sealing ring and a first wall portion of the annular channel, the second annular seal arranged between the sealing ring and a second wall portion of the annular channel; a second annular fluid chamber being at least partially delineated by a third annular seal, the annular channel, the sealing ring, and a fourth annular seal, the third annular seal arranged between the sealing ring and a third wall portion of the annular channel, the fourth annular seal arranged between the sealing ring and a fourth wall portion of the annular channel; and an annular fluid chamber situated between the first annular fluid chamber and the second annular fluid chamber and being at least partially defined between the second annular seal, the annular channel, the sealing ring, and the third annular seal; wherein the annular fluid chamber is configured to hold therewithin and transfer a fluid between the first fluid passage and the second fluid passage while the sealing ring is rotated about the sealing body.
20. A centralized tire inflation system comprising: a tire inflation system of embodiment 19, a control system, an operator control panel, and an air supply assembly.

In closing, foregoing descriptions of embodiments of the present invention have been presented for the purposes of illustration and description. It is to be understood that, although aspects of the present invention are highlighted by referring to specific embodiments, one skilled in the art will readily appreciate that these described embodiments are only illustrative of the principles comprising the present invention and such examples are not limiting thereto. As such, the specific embodiments are not intended to be exhaustive or to limit the invention to the precise forms disclosed. The use of any and all examples or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

In addition, groupings of alternative embodiments, elements, steps and/or limitations of the present invention are not to be construed as limitations. Each such grouping may be referred to and claimed individually or in any combination with other groupings disclosed herein. It is anticipated that one or more alternative embodiments, elements, steps and/or limitations of a grouping may be included in, or deleted from, the grouping for reasons of convenience and/or patentability. When any such inclusion or deletion occurs, the specification is deemed to contain the grouping as modified, thus fulfilling the written description of all Markush groups used in the appended claims. In addition, all methods described herein can be performed in any suitable order unless otherwise indicated herein or otherwise clearly contradicted by context. Therefore, it should be understood that embodiments of the disclosed subject matter are in no way limited to a particular element, compound, composition, component, article, apparatus, methodology, use, protocol, step, and/or limitation described herein, unless expressly stated as such.

While aspects of the invention have been described with reference to at least one exemplary embodiment, it is to be clearly understood by those skilled in the art that the invention is not limited thereto. Furthermore, those of ordinary skill in the art will recognize that certain changes, modifications, permutations, alterations, additions, subtractions, and sub-combinations thereof can be made in accordance with the teachings herein without departing from the spirit of the present invention. It is intended that the following appended claims and claims hereafter introduced are interpreted to include all such changes, modifications, permutations, alterations, additions, subtractions, and sub-combinations as are within their true spirit and scope. Accordingly, the scope of the present invention is not to be limited to that precisely as shown and described by this specification. Rather, the scope of the invention is to be interpreted only in conjunction with the appended claims and it is made clear, here, that the inventor(s) believe that the claimed subject matter is the invention.

Certain embodiments of the present invention are described herein, including the best mode known to the inventors for conducting the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

The words, language, and terminology used in this specification is for the purpose of describing particular embodiments, elements, steps and/or limitations only and is not intended to limit the scope of the present invention, which is defined solely by the claims. In addition, such words, language, and terminology are to be understood not only in the sense of their commonly defined meanings, but to include by special definition in this specification structure, material or acts beyond the scope of the commonly defined meanings. Thus, if an element, step or limitation can be understood in the context of this specification as including more than one meaning, then its use in a claim must be understood as being generic to all possible meanings supported by the specification and by the word itself.

The definitions and meanings of the elements, steps or limitations recited in a claim set forth below are, therefore, defined in this specification to include not only the combination of elements, steps or limitations which are literally set forth, but all equivalent structure, material or acts for performing substantially the same function in substantially the same way to obtain substantially the same result. In this sense it is therefore contemplated that an equivalent substitution of two or more elements, steps and/or limitations may be made for any one of the elements, steps or limitations in a claim set forth below or that a single element, step, or limitation may be substituted for two or more elements, steps and/or limitations in such a claim. Although elements, steps or limitations may be described above as acting in certain combinations and even initially claimed as such, it is to be expressly understood that one or more elements, steps and/or limitations from a claimed combination can in some cases be excised from the combination and that the claimed combination may be directed to a sub-combination or variation of a sub-combination. As such, notwithstanding the fact that the elements, steps and/or limitations of a claim are set forth below in a certain combination, it must be expressly understood that the invention includes other combinations of fewer, more, or different elements, steps and/or limitations, which are disclosed in above combination even when not initially claimed in such combinations. Furthermore, insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. Accordingly, the claims are thus to be understood to include what is specifically illustrated and described above, what is conceptually equivalent, what can be obviously substituted and also what essentially incorporates the essential idea of the invention.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Unless the context dictates the contrary, all ranges set forth herein should be interpreted as being inclusive of their endpoints and open-ended ranges should be interpreted to include only commercially practical values. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, all lists of values should be considered as inclusive of intermediate values unless the context indicates the contrary.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a comparable manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators-such as, e.g., “first,” “second,” “third,” etc.—for identified elements are used to distinguish between the elements, and do not indicate or imply a required or limited number of such elements, and do not indicate a particular position or order of such elements unless otherwise specifically stated.

When used in the claims, whether as filed or added per amendment, the open-ended transitional term “comprising”, variations thereof such as, e.g., “comprise” and “comprises”, and equivalent open-ended transitional phrases thereof like “including”, “containing” and “having”, encompass all the expressly recited elements, limitations, steps, integers, and/or features alone or in combination with unrecited subject matter; the named elements, limitations, steps, integers, and/or features are essential, but other unnamed elements, limitations, steps, integers, and/or features may be added and still form a construct within the scope of the claim. Specific embodiments disclosed herein may be further limited in the claims using the closed-ended transitional phrases “consisting of” or “consisting essentially of” (or variations thereof such as, e.g., “consist of”, “consists of”, “consist essentially of”, and “consists essentially of”) in lieu of or as an amendment for “comprising.” When used in the claims, whether as filed or added per amendment, the closed-ended transitional phrase “consisting of” excludes any element, limitation, step, integer, or feature not expressly recited in the claims. The closed-ended transitional phrase “consisting essentially of” limits the scope of a claim to the expressly recited elements, limitations, steps, integers, and/or features and any other elements, limitations, steps, integers, and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps, integers, and/or features specifically recited in the claim, whereas the meaning of the closed-ended transitional phrase “consisting essentially of” is being defined as only including those elements, limitations, steps, integers, and/or features specifically recited in the claim and those elements, limitations, steps, integers, and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such, the embodiments described herein or so claimed with the phrase “comprising” expressly and unambiguously provide description, enablement, and support for the phrases “consisting essentially of” and “consisting of.”

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

Any claims intended to be treated under 35 U.S.C. § 112 (f) will begin with the words “means for,” but use of the term “for” in any other context is not intended to invoke treatment under 35 U.S.C. § 112 (f). Accordingly, Applicant reserves the right to pursue additional claims after filing this application, in either this application or in a continuing application.

It should be understood that the methods and the order in which the respective elements of each method are performed are purely exemplary. Depending on the implementation, they may be performed in any order or in parallel, unless indicated otherwise in the present disclosure.

Finally, all patents, patent publications, and other references cited and identified in the present specification are individually and expressly incorporated herein by reference in their entirety to the same extent as if each individual publication or patent application were specifically and individually indicated to be incorporated by reference. These publications are provided solely for their disclosure prior to the filing date of the present application. The reference to any prior art in this specification is not, and should not be taken as, an acknowledgement or any form of suggestion that the prior art forms part of the common general knowledge from any country. In addition, where a definition or use of a term in an incorporated reference is inconsistent or contrary to the definition of that term provided herein, the definition of that term provided herein applies and the definition of that term in the reference does not apply. Lastly, nothing in this regard is or should be construed as an admission that the inventors are not entitled to antedate such disclosure by virtue of prior invention or for any other reason. All statements as to the date or representation as to the contents of these documents are based on the information available to the applicant and do not constitute any admission as to the correctness of the dates or contents of these documents.

1. A tire inflation system comprising:
a rotating outer hub comprising a first air channel;
a stationary inner hub comprising a second air channel; and
an annular air channel, the annular air chamber provides gaseous communication between the first air channel and the second air channel;
wherein the first air channel provides gaseous communication between a stem valve of a tire and the annular air chamber;
wherein the second air channel provides gaseous communication between an air source to the annular air chamber; and
wherein the tire inflation system is configured to reversibly attach to a hub assembly of a vehicle and configured to receive for reversable attachment a wheel of the vehicle.

2. The tire inflation system of claim 1, wherein the rotating outer hub further comprises a first annular fluid channel and a second annular fluid channel, the first annular fluid channel and second annular fluid channel surrounding the annular air chamber to form a seal around the annular air chamber.

3. The tire inflation system of claim 2, wherein the stationary inner hub further comprises a third annular fluid channel, wherein the third annular fluid channel is in fluid communication with the first annular fluid channel and second annular fluid channel.

4. The tire inflation system of claim 1, wherein the rotating outer hub comprises an inner air seal, and an outer air seal, wherein the inner air seal and the outer air seal form the annular air chamber.

5. The tire inflation system of claim 1, wherein the rotating outer hub comprises a sealing body and an inner sealing ring, wherein the sealing body and the inner sealing ring form a first annular fluid channel.

6. The tire inflation system of claim 1, wherein the rotating outer hub comprises an upper fluid seal, wherein the upper fluid seal form a second annular fluid channel.

7. The tire inflation system of claim 1, wherein the stationary inner hub comprises an inner sealing ring, an outer sealing ring, and a lower fluid seal, the lower fluid seal forming a third annular fluid channel.

8. The tire inflation system of claim 1, wherein the stationary inner hub comprises a combined sealing ring and a lower fluid seal, the lower fluid seal forming a third annular fluid channel.

9. A centralized tire inflation system comprising: a tire inflation system of claim 1, a control system, an operator control panel, and an air supply assembly.

10. A tire inflation apparatus comprising:
a ring housing, the ring housing comprising
a sealing body;
a ring assembly, the ring assembly having a ring assembly air channel; and
a sealing assembly, the sealing assembly comprising an inner air seal and an outer air seal configured to form an annular air chamber;
wherein the ring housing is configured to reversibly attach to a hub assembly of a vehicle and configured to receive for reversable attachment a wheel of the vehicle;
a ring housing hose, the ring housing hose having a first fitting configured to reversibly and securely attached to a tire stem value of a tire and a second fitting configured to reversibly and securely attach to a housing attachment port on the ring housing;
a ring assembly hose, the ring assembly hose having a first fitting configured to reversibly and securely attached to an attachment port on the ring assembly and a second fitting configured to reversibly and securely attach to a port of an air source;
wherein the ring housing hose and ring housing comprise a first air channel providing gaseous communication between the tire stem valve and the annular air chamber,
wherein the ring assembly hose and the ring assembly comprise a second air channel providing gaseous communication between the air source to the annular air chamber, and
wherein the annular air chamber provides gaseous communication between the first air channel and the second air channel.

11. The tire inflation system of claim 10, wherein the sealing body rotates in unison with the hub assembly and the wheel of the vehicle.

12. The tire inflation system of claim 10, wherein the ring assembly remains in a stationary position in relation to the rotational movement of the hub assembly and the wheel of the vehicle.

13. The tire inflation system of claim 10, wherein the sealing body further comprises a first annular fluid channel and a second annular fluid channel, the first annular fluid channel and second annular fluid channel surrounding the annular air chamber to form a seal around the annular air chamber.

14. The tire inflation system of claim 13, wherein the ring assembly further comprises a third annular fluid channel, wherein the third annular fluid channel is in fluid communication with the first annular fluid channel and second annular fluid channel.

15. The tire inflation system of claim 10, wherein the ring assembly comprises an inner sealing ring, wherein the sealing body and the inner sealing ring form a first annular fluid channel.

16. The tire inflation system of claim 10, wherein the sealing body comprises an upper fluid seal, wherein the upper fluid seal form a second annular fluid channel.

17. The tire inflation system of claim 10, wherein the ring assembly comprises a lower fluid seal, the lower fluid seal forming a third annular fluid channel.

18. A centralized tire inflation system comprising: a tire inflation system of claim 10, a control system, an operator control panel, and an air supply assembly.

19. A tire inflation system comprising:
a sealing body having a hub and an annular air channel formed concentrically around the hub, a first air passage arranged within the annular channel and formed through the sealing body;
a sealing ring arranged concentric with and at least partially within the annular air channel and surrounding the hub, the inner ring being rotatably coupled with the sealing body through a bearing, a second fluid passage formed through the sealing ring;
a first annular fluid chamber being at least partially delineated by a first annular seal, the annular channel, the sealing ring, and a second annular seal, the first annular seal arranged between the sealing ring and a first wall portion of the annular channel, the second annular seal arranged between the sealing ring and a second wall portion of the annular channel;
a second annular fluid chamber being at least partially delineated by a third annular seal, the annular channel, the sealing ring, and a fourth annular seal, the third annular seal arranged between the sealing ring and a third wall portion of the annular channel, the fourth annular seal arranged between the sealing ring and a fourth wall portion of the annular channel; and
an annular fluid chamber situated between the first annular fluid chamber and the second annular fluid chamber and being at least partially defined between the second annular seal, the annular channel, the sealing ring, and the third annular seal;
wherein the annular fluid chamber is configured to hold therewithin and transfer a fluid between the first fluid passage and the second fluid passage while the sealing ring is rotated about the sealing body.

20. A centralized tire inflation system comprising: a tire inflation system of claim 19, a control system, an operator control panel, and an air supply assembly.
